(19) United States
(12) Patent Application Publication
(10) Pub. No.: US 2015/0210792 A1
(43) Pub. Date: Jul. 30, 2015

(54) PHOTO-ALIGNMENT POLYMER, ALIGNMENT LAYER AND LIQUID CRYSTAL RETARDATION FILM COMPRISING THE SAME

(71) Applicant: LG CHEM, LTD., Seoul (KR)

(72) Inventors: Jeong Yoon Han, Daejeon (KR); Dong Woo Yoo, Daejeon (KR); Sung Kyoung Lee, Daejeon (KR); Sung-Ho Chun, Daejeon (KR); Dai Seung Choi, Daejeon (KR)

(21) Appl. No.: 14/419,634

(22) PCT Filed: Sep. 5, 2013
(86) PCT No.: PCT/KR2013/008025

§ 371 Date: Feb. 4, 2015

(30) Foreign Application Priority Data
Sep. 7, 2012 (KR) 10-2012-0099570
Sep. 5, 2013 (KR) 10-2013-0106598

(51) Int. Cl. C08F 132/08; G02B 27/22; G02F 1/1337; G02B 5/32

(52) U.S. Cl. CPC C08F 132/08; G02B 5/32; G02B 27/22; G02F 1/133753; G02F 1/133711; G02F 1/133788; G02F 2001/133757

(57) ABSTRACT

Disclosed herein is a photo-alignment polymer, which can be preferably applied to an alignment layer or the like of a three-dimensional display device because its alignment direction is easily changed depending on the polarization direction, and an alignment layer and liquid crystal retardation film including the same. The photo-alignment layer includes a cyclic olefin repeating unit substituted with one or more photoreactive groups, and has an absorbance ratio of 0.02 or more, the absorbance ratio being defined by Mathematical Formula 1 above, when the photo-alignment polymer is exposed to first polarized UV radiation having a wavelength of 280 to 315 nm and a first polarization direction at an exposure intensity of 60 mJ/cm² or less to conduct first photo-alignment and is then exposed to second polarized UV radiation having a wavelength of 280 to 315 nm and a second polarization direction changed by 90° from the first polarization direction at an exposure intensity of 60 mJ/cm² or less to conduct second photo-alignment.

### TECHNICAL FIELD

The present invention relates to a photo-alignment polymer and an alignment layer and liquid crystal retardation film including the same. More particularly, the present invention relates to a photo-alignment polymer, which can be preferably applied to an alignment layer or the like of a three-dimensional display device because its alignment direction is easily changed depending on the polarization direction, and an alignment layer and liquid crystal retardation film including the same.

### BACKGROUND OF THE INVENTION

With the recent advent of large-sized LCDs and the gradual expansion of their usage from portable devices, such as mobile phones, notebook computers, etc., to home appliances, such as wall mounted flat panel TVs, etc., there is a demand for LCDs with high image quality, high definition and a wide viewing angle. In particular, thin film transistor LCDs (TFT-LCDs), each pixel of which is independently driven, are much superior in response speed of liquid crystals to realize high-definition motion pictures, and thus increasingly used in a wider range of applications.

To be used as an optical switch in the TFT-LCDs, liquid crystals are required to be initially aligned in a defined direction on a layer including the innermost TFT of the display cell. For this, a liquid crystal alignment layer is used.

For the liquid crystal alignment to occur, a heat-resistant polymer such as polyimide is applied on a transparent glass to form a polymer alignment layer, which is then subjected to a rubbing process using a rotary roller wound with a rubbing cloth of nylon or rayon fabrics at a high rotation speed to align liquid crystals. However, the rubbing process leaves mechanical scratches on the surface of the liquid crystal alignment layer or generates strong static electricity, thus possibly destroying the TFTs. Further, fine fibers coming from the rubbing cloth may cause defects, which become an obstacle to acquiring a higher production yield.

To overcome the problems with the rubbing process and achieve innovation in the aspect of production yield, there has newly been devised a liquid crystal alignment method using a light such as UV radiation (hereinafter, referred to as “photo-alignment”).

Photo-alignment refers to a mechanism for forming a photo-polymerized liquid crystal alignment layer with aligned liquid crystals by causing the photoreactive groups bonded with a photo-alignment polymer to participate in a photoreaction and thus aligning the main chain of the polymer in a predetermined direction.

The representative example of the photo-alignment is photopolymerization-based photo-alignment as disclosed by M. Schadt et al. (Jpn. J. Appl. Phys., Vol 31., 1992, 2155), Dae S. Kang et al. (U.S. Pat. No. 5,464,669), and Yuriy Reznikov (Jpn. J. Appl. Phys. Vol. 34, 1995, L1000). The photo-alignment polymers used in these patent and research papers are mostly polycinnamate-based polymers, such as poly(vinylcinnamate) (PVCN) or poly(vinyl methoxycinnamate) (PVMC). For photo-alignment of polymers, the double bond of cinnamate exposed to UV radiation participates in a [2+2] cycloaddition reaction to form cyclobutane, which provides anisotropy to cause liquid crystal molecules aligned in one direction, inducing liquid crystal alignment.

Besides, Japanese Unexamined Patent Application Publication No. 11-181127 (JP11-181127 A) discloses a polymer having a side chain including photoreactive groups such as cinnamate on a main chain such as acrylate, methacrylate, etc., and an alignment layer including the same. Korean Patent Application Publication No. 2002-0006819 also discloses the use of an alignment layer including a polymethacryl-based polymer.

Meanwhile, a photo-alignment polymer and an alignment layer using the same have recently been applied to the realization of three-dimensional images and the like. However, in order to realize three-dimensional images and the like using such photo-alignment, it is required to allow a single alignment layer to include photo-alignment polymers having different alignment directions from one another. Formerly, for this purpose, a composition containing photo-alignment polymers was applied onto a substrate, and then polarized lights having different polarization directions with respect to each region were applied to the composition applied on the substrate two or more times by a mask process, thus adjusting the alignment directions of the polymers included in their respective regions to be different from one another.

According to such a conventional technology, there were problems in that, since mask process had to be carried out two or more times, the process of forming the alignment layer became very complicated, the process yield thereof became low, and the production cost thereof became very high.

### SUMMARY OF THE INVENTION

The present invention provides a photo-alignment polymer, which can be preferably applied to an alignment layer or the like of a three-dimensional display device because its alignment direction is easily changed depending on the polarization direction.

Further, the present invention provides an alignment layer including the photo-alignment polymer and a liquid crystal retardation film including the alignment layer.

Further, the present invention provides a display device including the alignment layer or the liquid crystal retardation film.

The present invention provides a photo-alignment polymer including a cyclic olefin repeating unit substituted with one or more photoreactive groups, wherein, when the photo-alignment polymer is exposed to first polarized UV radiation having a wavelength of 280 to 315 nm and a first polarization direction at an exposure intensity of 60 mJ/cm² or less to conduct first photo-alignment and is then exposed to second polarized UV radiation having a wavelength of 280 to 315 nm and a second polarization direction changed by 90° from the first polarization direction at an exposure intensity of 60 mJ/cm² or less to conduct second photo-alignment, the photo-alignment polymer has an absorbance ratio of 0.02 or more, the absorbance ratio being defined by Mathematical Formula 1 below:

absorbance ratio(AR)=(|A1−A2|)/(A1+A2) [Mathematical Formula 1]

wherein A1 represents an absorbance of the photo-alignment polymer, which was measured at a maximum absorption wavelength of wavelengths of 280 to 330 nm after the first photo-alignment, and A2 represents an absorbance of the photo-alignment polymer, which was measured at a maximum absorption wavelength of wavelengths of 280 to 330 nm after the second photo-alignment.

In the photo-alignment polymer, the cyclic olefin repeating unit may include a repeating unit of the following Formula 3a or 3b:

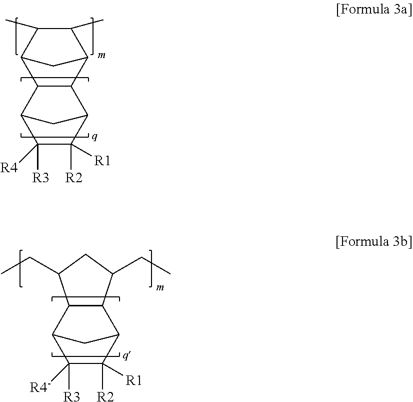

wherein independently, m is 50 to 5,000; q is an integer from 0 to 4; at least one of R1, R2, R3 and R4 is any one selected from the group consisting of radicals represented by the following Formulae 1a and 1b, among the R1 to R4, the remainders other than the radical of Formula 1a or 1b are the same as or different from one another and independently selected from the group consisting of hydrogen; halogen; substituted or unsubstituted linear or branched alkyl having 1 to 20 carbon atoms; substituted or unsubstituted linear or branched alkenyl having 2 to 20 carbon atoms; substituted or unsubstituted linear or branched alkynyl having 2 to 20 carbon atoms; substituted or unsubstituted cycloalkyl having 3 to 12 carbon atoms; substituted or unsubstituted aryl having 6 to 40 carbon atoms; and a polar functional group comprising at least one of oxygen, nitrogen, phosphor, sulfur, silicon, and boron,

when the R1 to R4 are not hydrogen, halogen, or a polar functional group, at least one of a R1 and R2 combination and a R3 and R4 combination is bonded to each other to form an alkylidene group having 1 to 10 carbon atoms; or R1 or R2 is bonded to either R3 or R4 to form a saturated or unsaturated aliphatic ring having 4 to 12 carbon atoms or an aromatic ring having 6 to 24 carbon atoms,

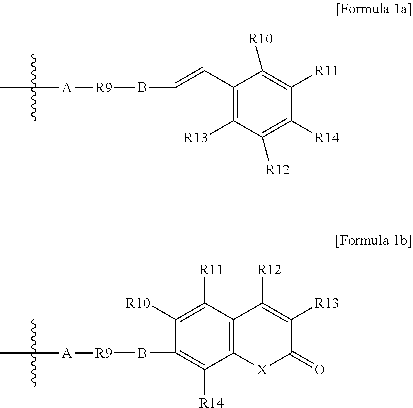

wherein A is chemical bond, oxygen, sulfur, or —NH—;

B is selected from the group consisting of a chemical bond, substituted or unsubstituted alkylene having 1 to 20 carbon atoms, carbonyl, carboxy, ester, substituted or unsubstituted arylene having 6 to 40 carbon atoms, and substituted or unsubstituted heteroarylene having 6 to 40 carbon atoms; X is oxygen or sulfur; R9 is selected from the group consisting of a chemical bond, substituted or unsubstituted alkylene having 1 to 20 carbon atoms, substituted or unsubstituted alkenylene having 2 to 20 carbon atoms, substituted or unsubstituted cycloalkylene having 3 to 12 carbon atoms, substituted or unsubstituted arylene having 6 to 40 carbon atoms, substituted or unsubstituted aralkylene having 7 to 15 carbon atoms, and substituted or unsubstituted alkynylene having 2 to 20 carbon atoms; at least one of R10 to R14 is a radical represented by -L-R15-R16-(substituted or unsubstituted C6-C40 aryl), among the R10 to R14, the remainders other than the radical of -L-R15-R16-(substituted or unsubstituted C6-C40 aryl) are the same as or different from one another and independently selected from the group consisting of hydrogen; halogen; substituted or unsubstituted alkyl having 1 to 20 carbon atoms; substituted or unsubstituted alkoxy having 1 to 20 carbon atoms; substituted or unsubstituted aryloxy having 6 to 30 carbon atoms; substituted or unsubstituted aryl having 6 to 40 carbon atoms; and heteroaryl having 6 to 40 carbon atoms with a hetero element in Group 14, 15 or 16; L is selected from the group consisting of oxygen, sulfur, —NH—, substituted or unsubstituted alkylene having 1 to 20 carbon atoms, carbonyl, carboxy, —CONH—, and substituted or unsubstituted arylene having 6 to 40 carbon atoms; R15 is substituted or unsubstituted alkyl having 1 to 10 carbon atoms; and R16 is selected from the group consisting of chemical bond, —O—, —C(═O)O—, —OC(═O)—, —NH—, —S—, and —C(═O)—.

The present invention also provides an alignment layer including the photo-alignment polymer and a liquid crystal retardation film including the photo-alignment polymer.

The present invention also provides a display device including the alignment layer or the liquid crystal retardation film.

The change in alignment direction of the photo-alignment polymer to polarization direction may occur very freely. For this reason, this photo-alignment polymer can be very preferably applied to patterned retardation films or patterned cell alignment layers, which are used in realizing three dimensional images. In particular, since the alignment direction of the photo-alignment polymer can be changed relatively freely, the patterned retardation films or cell alignment layer can be formed very efficiently using a single-mask process.

Accordingly, the photo-alignment polymer and the alignment layer including the same can be very preferably applied to various liquid crystal display devices used in realizing three dimensional images.

### BRIEF DESCRIPTION OF THE DRAWINGS

FIG. 1 is a schematic view showing an exemplary structure of a general alignment layer.

### DETAILED DESCRIPTION OF THE EMBODIMENTS

Hereinafter, preferred embodiments of the present invention will be described in detail with reference to the attached drawings.

In accordance with an embodiment of the invention, there is provided a photo-alignment polymer including a cyclic olefin repeating unit substituted with one or more photoreactive groups, wherein, when the photo-alignment polymer is exposed to first polarized UV radiation having a wavelength of 280 to 315 nm and a first polarization direction at an exposure intensity of 60 mJ/cm² or less to conduct first photo-alignment and is then exposed to second polarized UV radiation having a wavelength of 280 to 315 nm and a second polarization direction changed by 90° from the first polarization direction at an exposure intensity of 60 mJ/cm² or less to conduct second photo-alignment, the photo-alignment polymer has an absorbance ratio of 0.02 or more, the absorbance ratio being defined by Mathematical Formula 1 below:

absorbance ratio(AR)=(|A1−A2|)/(A1+A2) [Mathematical Formula 1]

wherein A1 represents an absorbance of the photo-alignment polymer, which was measured at a maximum absorption wavelength of wavelengths of 280 to 330 nm after the first photo-alignment, and A2 represents an absorbance of the photo-alignment polymer, which was measured at a maximum absorption wavelength of wavelengths of 280 to 330 nm after the second photo-alignment.

Generally, when photo-alignment polymers are exposed to polarized UV radiation having a predetermined polarization direction to conduct photo-alignment, a double bond included in a photoreactive group causes dimerization, and thus the photo-alignment polymers are arranged in any one direction to provide anisotropy, thus conducting photo-alignment. However, after dimerization and photo-alignment are caused by the exposure to polarized UV radiation, additionally-photoreactable structures are reduced, thus lowering absorbance. Therefore, it can be recognized that the difference between absorbance after first photo-alignment and absorbance after second photo-alignment is maintained at a predetermined level and that the dimerization and second photo-alignment easily takes place at a predetermined level when the second photo-alignment is conducted after the first photoalignment.

In particular, when the photo-alignment polymer according to an embodiment of the present invention is subject to second photo-alignment after first photo-alignment while changing a polarization direction, the absorbance ratio of Formula 1 reaches 0.02 or more. Further, even when this photo-alignment polymer is subject to second photo-alignment after first photo-alignment while changing a polarization direction, the alignment direction of photoreactive groups can be freely changed, thus causing dimerization and second photoalignment at a predetermined level. Therefore, in order to prepare a patterned retardation film or alignment layer using this photo-alignment polymer, it is not required to perform a mask process two times or more, and a patterned retardation film or alignment layer exhibiting excellent orientation with respect to each region can be prepared only by a single-mask process. That is, after a composition including the photo-alignment polymer is applied onto a substrate, the entire surface of the composition is first exposed to polarized UV radiation, and then only the predetermined region of the composition is second exposed to polarized UV radiation while changing the polarization direction, thus easily and efficiently obtaining a patterned retardation film or alignment layer in which the alignment direction of polymers is differently regulated with respect to each region. Accordingly, the photo-alignment polymer according to an embodiment of the present invention can be very preferably applied to the patterned retardation film or alignment layer used in realizing three-dimensional images.

In contrast, any previously-known photo-alignment polymer could not satisfy the above-mentioned characteristics. Particularly, conventional photo-alignment polymers are problematic in that their alignment direction does not move when this alignment direction is determined by predetermined-direction polarized radiation and in that second photo-alignment must be performed by different-direction polarized radiation having strong intensity even when the alignment direction moves. For this reason, in order to obtain a patterned retardation film using conventional photo-alignment polymers, polarized radiations having different directions from each other must be applied with respect to each region, and, for this, a mask process must be carried out two times or more.

Hereinafter, a photo-alignment polymer according to an embodiment of the present invention will be described in more detail.

The absorbance ratio (AR) of the photo-alignment polymer may be 0.02 or more, more specifically, 0.02 to 0.08 even when first and second photo-alignments are performed at low exposure intensity of 60 mJ/cm² or less, for example, 3 to 60 mJ/cm². As such, the alignment direction is freely changed even when the second photo-alignment is performed under low exposure intensity while changing the polarization direction, with the result that the second photo-alignment can be efficiently performed, thereby very easily providing a patterned retardation film or alignment layer only by a single-mask process.

More specifically, the absorbance ratio (AR) of the photo-alignment polymer may be 0.02 to 0.05 when the exposure intensity during first photo-alignment is 20 to 60 mJ/cm² and the exposure intensity during second photo-alignment is 3 to 60 mJ/cm². Further, the absorbance ratio (AR) of the photo-alignment polymer may be 0.02 to 0.08 or 0.03 to 0.08 when the exposure intensity during first photo-alignment is 3 to 20 mJ/cm² and the exposure intensity during second photo-alignment is 3 to 60 mJ/cm². Furthermore, the absorbance ratio (AR) of the photo-alignment polymer may be 0.04 to 0.08 when the exposure intensity during first photo-alignment is 3 to 20 mJ/cm² and the exposure intensity during second photo-alignment is 15 to 60 mJ/cm².

As such, the photo-alignment polymer can exhibit a predetermined level of change of alignment direction and degree of second photo-alignment according to the change in polarization direction even when few additionally photoreactable structures remain due to relatively strong exposure intensity during first photo-alignment. Moreover, the photo-alignment polymer can exhibit higher change of alignment direction and degree of second photo-alignment according to the change in polarization direction when the exposure intensity during first photo-alignment is relatively weak and the exposure intensity during second photo-alignment is relatively strong. Like this, since the degree of first and second photo-alignment and change of alignment direction during second photo-alignment can be regulated by adjusting the exposure time or exposure intensity during first and second photo-alignment, a patterned retardation film or alignment layer exhibiting desired orientation with respect to each region can be very efficiently provided using the photo-alignment polymer.

Further, since the above-mentioned photo-alignment polymer exhibits a predetermined level of change of alignment direction and degree of second photo-alignment according to the change in polarization direction as well as exhibits a predetermined level of absorbance after first photo-alignment due to its excellent photoreactivity and optical orientation, it can exhibit the above absorbance even after second photo-alignment. Therefore, a patterned retardation film or alignment layer can be very easily provided without performing a mask process two times using the photo-alignment polymer according to an embodiment of the present invention.

Meanwhile, the above-mentioned characteristics related to the absorbance ratio (AR) of the Mathematical Formula 1 or the like have not been able to be achieved by previously-known photo-alignment polymers, but can be achieved using a photo-alignment polymer obtained from a specific cyclic olefin compound. Hereinafter, such a cyclic olefin compound, photo-alignment polymer and preparation method thereof will be described in detail.

The above-mentioned characteristics according to an embodiment of the present invention can be accomplished by a photo-alignment polymer obtained using a cyclic olefin compound having a photoreactive group represented by the following Formula 1 as a monomer:

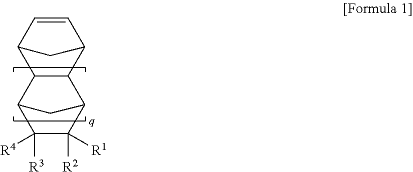

In Formula 1, q is an integer from 0 to 4; and at least one of R1, R2, R3 and R4 is any one selected from the group consisting of radicals of the following Formulae 1a and 1b. Among R1 to R4, the remainders other than the radical of Formula 1a or 1b are the same as or different from one another and independently selected from the group consisting of hydrogen; halogen; substituted or unsubstituted linear or branched alkyl having 1 to 20 carbon atoms; substituted or unsubstituted linear or branched alkenyl having 2 to 20 carbon atoms; substituted or unsubstituted linear or branched alkynyl having 2 to 20 carbon atoms; substituted or unsubstituted cycloalkyl having 3 to 12 carbon atoms; substituted or unsubstituted aryl having 6 to 40 carbon atoms; and a polar functional group comprising at least one of oxygen, nitrogen, phosphor, sulfur, silicon, and boron. When R1 to R4 are not hydrogen, halogen, or a polar functional group, at least one of a R1 and R2 coordination and a R3 and R4 coordination is bonded to each other to form an alkylidene group having 1 to 10 carbon atoms; or R1 or R2 is bonded to either R3 or R4 to form a saturated or unsaturated aliphatic ring having 4 to 12 carbon atoms or an aromatic ring having 6 to 24 carbon atoms.

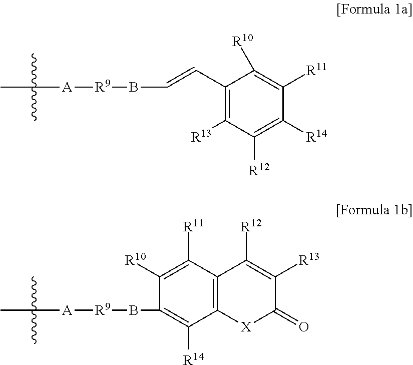

In Formulae 1a and 1b, A is chemical bond, oxygen, sulfur, or —NH—. B is selected from the group consisting of chemical bond, substituted or unsubstituted alkylene having 1 to 20 carbon atoms, carbonyl, carboxy, ester, substituted or unsubstituted arylene having 6 to 40 carbon atoms, and substituted or unsubstituted heteroarylene having 6 to 40 carbon atoms. X is oxygen or sulfur. R9 is selected from the group consisting of a chemical bond, substituted or unsubstituted alkylene having 1 to 20 carbon atoms, substituted or unsubstituted alkenylene having 2 to 20 carbon atoms, substituted or unsubstituted cycloalkylene having 3 to 12 carbon atoms, substituted or unsubstituted arylene having 6 to 40 carbon atoms, substituted or unsubstituted aralkylene having 7 to 15 carbon atoms, and substituted or unsubstituted alkynylene having 2 to 20 carbon atoms. At least one of R10 to R14 is a radical represented by -L-R15-R16-(substituted or unsubstituted C6-C40 aryl). Among R10 to R14, the remainders other than the radical of -L-R15-R16-(substituted or unsubstituted C6-C40 aryl) are the same as or different from one another and independently selected from the group consisting of hydrogen; halogen; substituted or unsubstituted alkyl having 1 to 20 carbon atoms; substituted or unsubstituted alkoxy having 1 to 20 carbon atoms; substituted or unsubstituted aryloxy having 6 to 30 carbon atoms; substituted or unsubstituted aryl having 6 to 40 carbon atoms; and heteroaryl having 6 to 40 carbon atoms with a hetero element in Group 14, 15 or 16. L is selected from the group consisting of oxygen, sulfur, —NH—, substituted or unsubstituted alkylene having 1 to 20 carbon atoms, carbonyl, carboxy, —CONH—, and substituted or unsubstituted arylene having 6 to 40 carbon atoms. R15 is substituted or unsubstituted alkyl having 1 to 10 carbon atoms. R16 is selected from the group consisting of chemical bond, —O—, —C(═O)O—, —OC(═O)—, —NH—, —S—, and —C(═O)—.

In such a cyclic olefin compound, in the radical of -L-R15-R16-(substituted or unsubstituted C6-C40 aryl), the linker L may be replaced by oxygen, and the ary may be replaced by phenyl. Therefore, the radical of -L-R15-R16- is represented by the following Formula 2:

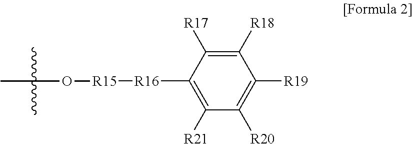

Besides, the radical of -L-R15-R16- may have various aryls and linkers L.

In Formula 2, R15 and R16 are as defined in Formula 1; and R17 to R21 are the same as or different from one another and independently selected from the group consisting of hydrogen; halogen; substituted or unsubstituted alkyl having 1 to 20 carbon atoms; substituted or unsubstituted alkoxy having 1 to 20 carbon atoms; substituted or unsubstituted aryloxy having 6 to 30 carbon atoms; substituted or unsubstituted aryl having 6 to 40 carbon atoms; heteroaryl having 6 to 40 carbon atoms with a hetero element in Group 14, 15 or 16; and substituted or unsubstituted alkoxyaryl having 6 to 40 carbon atoms.

More specifically, the radical represented by Formula 2 may be unsubstitued benzyloxy or benzyloxy substituted with halogen or alkoxy having 1 to 3 carbon atoms.

Such a cyclic olefin compound has a chemical structure in which the ends of photoreactive groups such as cinnamate are bonded to a substituent represented by -L-R15-R16-(substituted or unsubstituted C6-C40 aryl). The substituent comprises an aralkyl structure that alkyl and aryl groups are sequentially connected together via a linker L. Such a bulky chemical structure as aralkyl is connected to the ends of photoreactive groups via a linker L, confirming the formation of a large free volume between the photoreactive groups. This seems likely to be caused by the steric hindrance between adjacent bulky aralkyl structures.

For this reason, in the photo-alignment polymer and alignment layer prepared from the cyclic olefin compound, photoreactive groups such as cinnamate in the photoreactive polymer and the alignment layer prepared using the cyclic olefin compound are relatively free to move (flow) or react in such a large free volume, minimizing hindrance from other reactors or substituents. Consequently, photoreactive groups can change the alignment direction relatively freely according to the change of the polarization direction. For this reason, the alignment direction is more easily changed according to the polarization direction, so a photo-alignment polymer satisfying the above-mentioned characteristics can be provided, and this photo-alignment polymer can be preferably applied to a patterned retardation film or cell alignment layer used in the realization of three-dimensional images. More specifically, when the radical of -L-R15-R16-(substituted or unsubstituted C6-C40 aryl) is a radical represented by Formula 2, such as substituted or unsubstituted benzyloxy or the like, the alignment direction is more easily changed according to the polarization direction, thus providing a photo-alignment polymer satisfying the above-mentioned characteristics.

In the cyclic olefin compound, a polar functional group used as a substituent for R1 to R4, that is, a polar functional group including at least one of oxygen, nitrogen, phosphor, sulfur, silicon, and boron may be selected from the group consisting of the following functional groups, or otherwise, include at least one of oxygen, nitrogen, phosphor, sulfur, silicon, and boron:

—OR₆, —OC(O)OR₆, —R₅OC(O)OR₆, —C(O)OR₆, —R₅C(O)OR₆, —C(O)R₆, —R₅C(O)R₆, —OC(O)R₆, —R₅OC(O)R₆, —(R₅O)ₚ—OR₆, —(OR₅)ₚ—OR₆, —C(O)—O—C(O)R₆, —R₅C(O)—O—C(O)R₆, —SR₆, —R₅SR₆, —SSR₆, —R₅SSR₆, —S(═O)R₆, —R₅S(═O)R₆, —R₅C(═S)R₆—, —R₅C(═S)SR₆, —R₅SO₃R₆, —SO₃R₆, —R₅N═C═S, —N═C═S, —NCO, —R₅—NCO, —CN, —R₅CN, —NNC(═S)R₆, —R₅NNC(═S)R₆, —NO₂, —R₅NO₂,

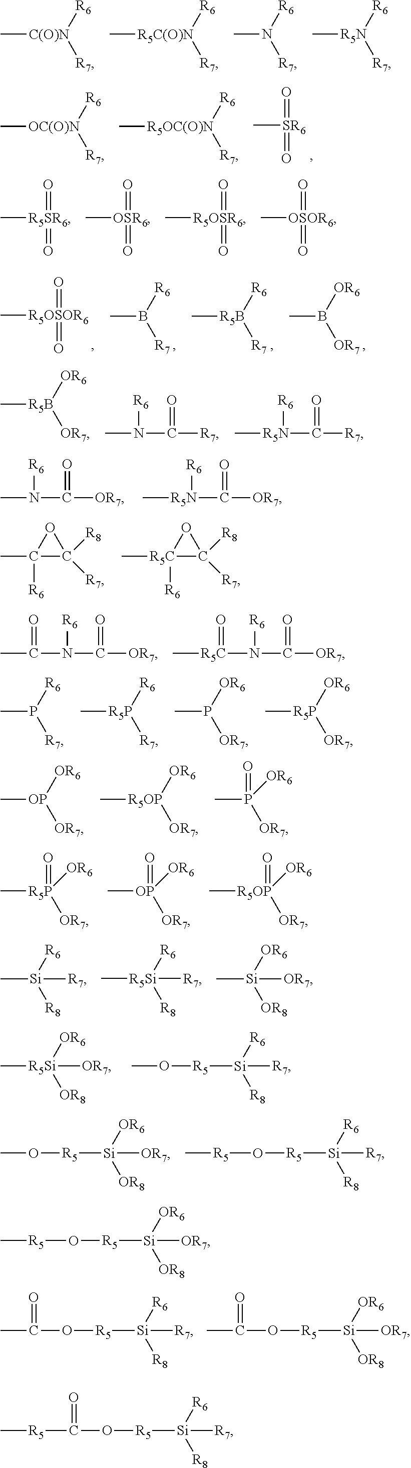

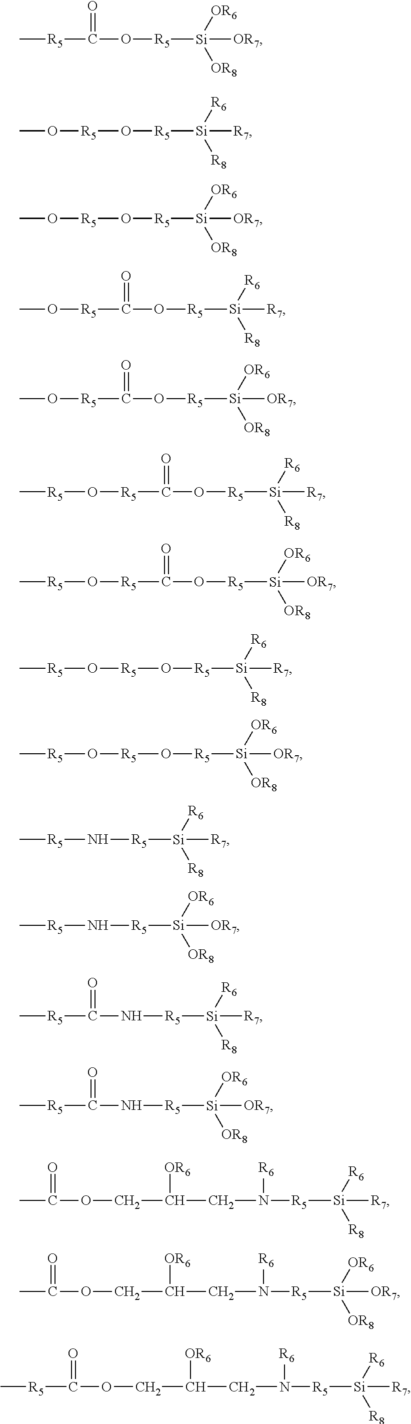

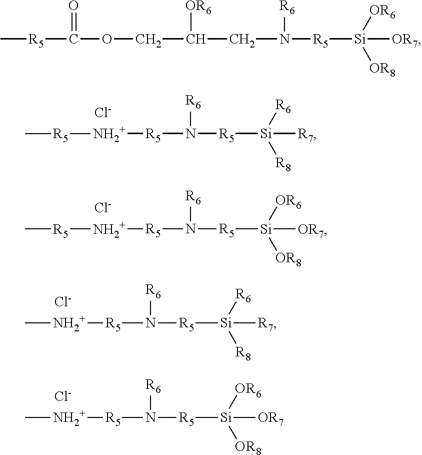

In the polar functional groups, independently, p is an integer from 1 to 10. R5 is substituted or unsubstituted linear or branched alkylene having 1 to 20 carbon atoms; substituted or unsubstituted linear or branched alkenylene having 2 to 20 carbon atoms; substituted or unsubstituted linear or branched alkynylene having 2 to 20 carbon atoms; substituted or unsubstituted cycloalkylene having 3 to 12 carbon atoms; substituted or unsubstituted arylene having 6 to 40 carbon atoms; substituted or unsubstituted carbonyloxylene having 1 to 20 carbon atoms; or substituted or unsubstituted alkoxylene having 1 to 20 carbon atoms. R6, R7 and R8 are independently selected from the group consisting of hydrogen; halogen; substituted or unsubstituted linear or branched alkyl having 1 to 20 carbon atoms; substituted or unsubstituted linear or branched alkenyl having 2 to 20 carbon atoms; substituted or unsubstituted linear or branched alkynyl having 2 to 20 carbon atoms; substituted or unsubstituted cycloalkyl having 3 to 12 carbon atoms; substituted or unsubstituted aryl having 6 to 40 carbon atoms; substituted or unsubstituted alkoxy having 1 to 20 carbon atoms; and substituted or unsubstituted carbonyloxy having 1 to 20 carbon atoms.

In the cyclic olefin compound, the substituted or unsubstituted aryl having 6 to 40 carbon atoms or the heteroaryl having 6 to 40 carbon atoms with an hetero element in Group 14, 15 or 16 is selected from the group consisting of the following functional groups; or may be other different aryl or heteroaryl groups:

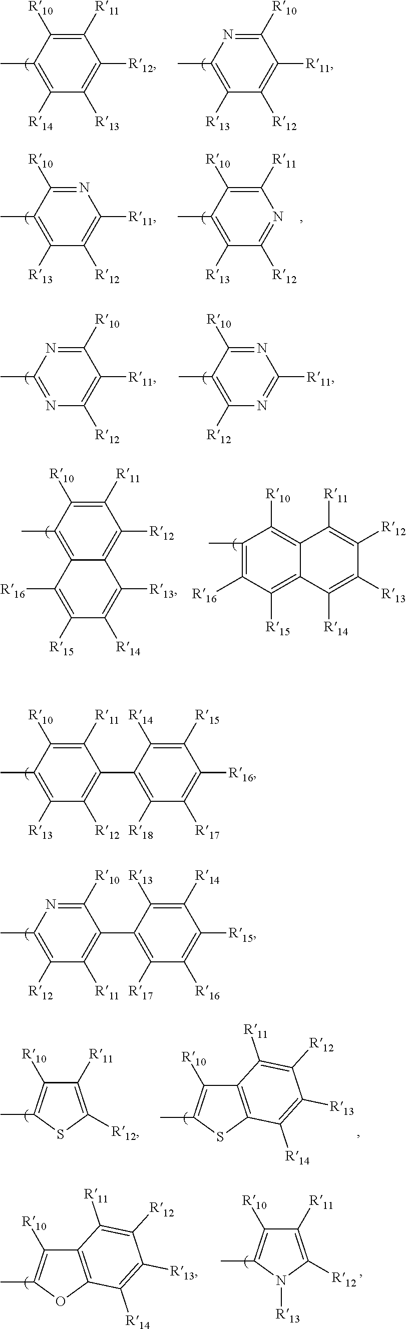

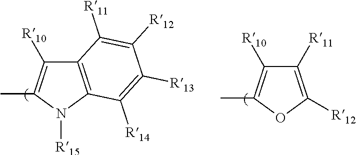

In the functional groups, R′10 to R′18 are the same as or different from one another and independently selected from the group consisting of substituted or unsubstituted linear or branched alkyl having 1 to 20 carbon atoms; substituted or unsubstituted alkoxy having 1 to 20 carbon atoms; substituted or unsubstituted aryloxy having 6 to 30 carbon atoms; and substituted or unsubstituted aryl having 6 to 40 carbon atoms.

In the cyclic olefin compound, at least one of the R1 to R4 of Formula 1 is a photoreactive group of Formula 1a or 1b. For example, at least one of R1 and R2 may be the photoreactive group. The use of the cyclic olefin compound enables the preparation of a photoreactive polymer having good characteristics such as alignment or the like.

Meanwhile, in the above-described structure of the cyclic olefin compound, the respective substituents are defined as follows.

First, the term “alkyl” as used herein refers to a monovalent linear or branched saturated hydrocarbon portion having 1 to 20 carbon atoms, preferably 1 to 10 carbon atoms, more preferably 1 to 6 carbon atoms. The alkyl group inclusively refers to alkyl groups unsubstituted or additionally substituted with a specific substituent, which will be described later. The examples of the alkyl group may comprise methyl, ethyl, propyl, 2-propyl, n-butyl, iso-butyl, tert-butyl, pentyl, hexyl, dodecyl, fluoromethyl, difluoromethyl, trifluoromethyl, chloromethyl, dichloromethyl, trichloromethyl, iodomethyl, bromomethyl, etc.

The term “alkenyl” as used herein refers to a monovalent linear or branched hydrocarbon portion having 2 to 20 carbon atoms, preferably 2 to 10 carbon atoms, more preferably 2 to 6 carbon atoms with at least one carbon-carbon double bond. The alkenyl group may form a bond through carbon atoms including a carbon-carbon double bond or through saturated carbon atoms. The alkenyl group inclusively refers to alkenyl groups unsubstituted or additionally substituted with a specific substituent, which will be described later. The examples of the alkenyl group may comprise ethenyl, 1-propenyl, 2-propenyl, 2-butenyl, 3-butenyl, pentenyl, 5-hexenyl, dodecenyl, etc. The term “cycloalkyl” as used herein refers to a monovalent saturated or unsaturated mono-, bi- or tri-cyclic non-aromatic hydrocarbon portion having 3 to 12 ring-carbon atoms. The cycloalkyl group inclusively refers to cycloalkyl groups additionally substituted with a specific substituent, which will be described later. The examples of the cycloalkyl group may comprise cyclopropyl, cyclobutyl, cyclopentyl, cyclopentenyl, cyclohexyl, cyclohexenyl, cycloheptyl, cyclooctyl, decahydronaphthalenyl, adamantyl, norbornyl (i.e., bicyclo[2,2,1]hept-5-enyl), etc.

The term “aryl” as used herein refers to a monovalent mono-, bi- or tri-cyclic aromatic hydrocarbon portion having 6 to 40 ring-carbon atoms, preferably 6 to 12 ring-carbon atoms. The aryl group inclusively refers to aryl groups additionally substituted with a specific substituent, which will be described later. The examples of the aryl group may comprise phenyl, naphthalenyl, fluorenyl, etc.

The term “alkoxyaryl” as used herein refers to the above-defined aryl group in which at least one hydrogen atom is substituted by an alkoxy group. The examples of the alkoxyaryl group may comprise methoxyphenyl, ethoxyphenyl, propoxyphenyl, butoxyphenyl, pentoxyphenyl, hextoxyphenyl, heptoxy, octoxy, nanoxy, methoxybiphenyl, methoxynaphthalenyl, methoxyfluorenyl, methoxyanthracenyl, etc.

The term “aralkyl” as used herein refers to the above-defined alkyl group in which at least one hydrogen atom is substituted by an aryl group. The aralkyl group inclusively refers to aralkyl groups additionally substituted with a specific substituent, which will be described later. The examples of the aralkyl may comprise benzyl, benzhydryl, trityl, etc.

The term “alkynyl” as used herein refers to a monovalent linear or branched hydrocarbon portion having 2 to 20 carbon atoms, preferably 2 to 10 carbon atoms, more preferably 2 to 6 carbon atoms with at least one carbon-carbon triple bond. The alkynyl group may form a bond through carbon atoms including a carbon-carbon triple bond or through saturated carbon atoms. The alkynyl group inclusively refers to alkynyl groups additionally substituted with a specific substituent, which will be described later. The examples of the alkynyl group may comprise ethynyl, propynyl, etc.

The term “alkylene” as used herein refers to a divalent linear or branched saturated hydrocarbon portion having 1 to 20 carbon atoms, preferably 1 to 10 carbon atoms, more preferably 1 to 6 carbon atoms. The alkylene group inclusively refers to alkylene groups additionally substituted with a specific substituent, which will be described later. The examples of the alkylene group may comprise methylene, ethylene, propylene, butylene, hexylene, etc.

The term “alkenylene” as used herein refers to a divalent linear or branched hydrocarbon portion having 2 to 20 carbon atoms, preferably 2 to 10 carbon atoms, more preferably 2 to 6 carbon atoms with at least one carbon-carbon double bond. The alkenylene group may form a bond through carbon atoms including a carbon-carbon double bond and/or through saturated carbon atoms. The alkenylene group inclusively refers to alkenylene groups additionally substituted with a specific substituent, which will be described later.

The term “cycloalkylene” as used herein refers to a divalent saturated or unsaturated mono-, bi- or tri-cyclic non-aromatic hydrocarbon portion having 3 to 12 ring-carbon atoms. The cycloalkylene group inclusively refers to cycloalkylene groups additionally substituted with a specific substituent, which will be described later. The examples of the cycloalkylene group may comprise cyclopropylene, cyclobutylene, etc.

The term “arylene” as used herein refers to a divalent mono-, bi- or tri-cyclic aromatic hydrocarbon portion having 6 to 20 ring-carbon atoms, preferably 6 to 12 ring-carbon atoms. The arylene group inclusively refers to arylene groups additionally substituted with a specific substituent, which will be described later. The aromatic portion includes carbon atoms only. The examples of the arylene may comprise phenylene, etc.

The term “aralkylene” as used herein refers to a divalent portion of the above-defined alkyl group in which at least one hydrogen atom is substituted by an aryl group. The aralkylene group inclusively refers to aralkylene groups additionally substituted with a specific substituent, which will be described later. The examples of the aralkylene group may comprise benzylene, etc.

The term “alkynylene” as used herein refers to a divalent linear or branched hydrocarbon portion having 2 to 20 carbon atoms, preferably 2 to 10 carbon atoms, more preferably 2 to 6 carbon atoms with at least one carbon-carbon triple bond. The alkynylene group may form a bond through carbon atoms including a carbon-carbon triple bond or through saturated carbon atoms. The alkynylene group inclusively refers to alkynylene groups additionally substituted with a specific substituent, which will be described later. The examples of the alkynylene group may comprise ethynylene, propynylene, etc.

In the above description, the phrase “a substituent is substituted or unsubstituted” has an inclusive meaning that the substituent is or isn't additionally substituted with the substituent itself or another specific substituent. If not stated otherwise in this specification, the examples of the substituent used as an additional substituent for each substituent may include halogen, alkyl, alkenyl, alkynyl, haloalkyl, haloalkenyl, haloalkynyl, aryl, haloaryl, aralkyl, haloaralkyl, alkoxy, haloalkoxy, carbonyloxy, halocarbonyloxy, aryloxy, haloaryloxy, silyl, siloxy, or “a polar functional group comprising oxygen, nitrogen, phosphor, sulfur, silicon, or boron” as mentioned above.

The above-described cyclic olefin compound may be prepared by a typical method of introducing a defined substituent, more specifically, a photoreactive group of Formula 1a or 1b on a cyclic olefin such as a norbornene-based compound. The synthesis of the cyclic olefin compound involves, for example, a condensation reaction of norbornene (alkyl)ol, such as norbornene methanol, and a carboxylic compound or the like having a photoreactive group of Formula 1a or 1b. Depending on the structure and the type of the photoreactive group of Formula 1a or 1b, any other different methods can be used to introduce the photoreactive group and prepare the cyclic olefin compound.

Meanwhile, when the above-mentioned cyclic olefin compound is used, a photo-alignment polymer satisfying the characteristics of an embodiment of the present invention can be obtained. Such a photo-alignment polymer may include a repeating unit of the following Formula 3a or 3b as a cyclic olefin repeating unit (main repeating unit):

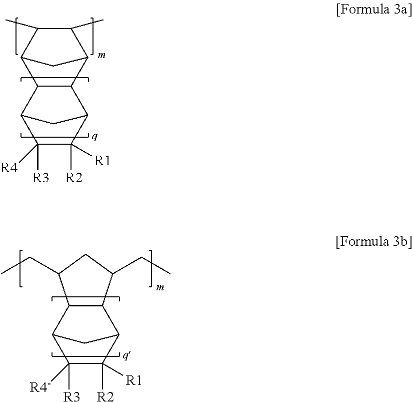

In Formulae 3a and 3b, independently, m is 50 to 5,000; and q, R1, R2, R3 and R4 are as defined in Formula 1.

This photo-alignment polymer, which includes a repeating unit derived from the cyclic olefin compound, supports the formation of a large free volume between adjacent photoreactive groups owing to the bulky aralkyl structure connected to the ends of the photoreactive groups via a linker L. In the photo-alignment polymer, consequently, the photoreactive groups are relatively free to move (flow) or react in the secured large free volume. Hence, the photo-alignment polymer can relatively freely change the alignment direction according to the polarization direction and can exhibit better excellences in the second photo-alignment, thereby satisfying the characteristics of an embodiment of the present invention.

In addition, the photo-alignment polymer may include a norbornene-based repeating unit of Formula 3a or 3b as a main repeating unit. The norbornene-based repeating unit is structurally rigid, and the photo-alignment polymer including the norbornene-based repeating unit has a relatively high glass transition temperature Tg of about 300° C. or above, preferably about 300 to 350° C., consequently with a higher thermal stability than the existing photoreactive polymers.

The definitions of the respective substituents bonded to the photo-alignment polymer are specified above in detail in regard to the cyclic olefin compound of Formula 1 and will not be described any more.

The photo-alignment polymer may include at least one repeating unit selected from the group consisting of the repeating units of Formula 3a or 3b, or may be a copolymer further including another type of repeating unit. The examples of the repeating unit may include any olefin-, acrylate- or cyclic-olefin-based repeating unit with or without a bond to cinnamate-, chalcone- or azo-based photoreactive groups. The exemplary repeating units are disclosed in Korean Patent Application Publication No. 2010-0021751.

In order to prevent the deterioration in good characteristics such as alignment and alignment rate pertaining to Formula 3a or 3b, the photo-alignment polymer may include the repeating unit of Formula 3a or 3b in an amount of at least about 50 mol %, more specifically about 50 to 100 mol %, preferably at least about 70 mol %.

The repeating unit of Formula 3a or 3b constituting the photo-alignment polymer has a degree of polymerization in the range of about 50 to 5,000, preferably about 100 to 4,000, more preferably about 1,000 to 3,000. The photo-alignment polymer has a weight average molecular weight of 10,000 to 1000,000, preferably 20,000 to 500,000. The photo-alignment polymer properly included in a coating composition for forming an alignment layer provides the coating composition with good coatability and the alignment layer formed from the coating composition with good liquid crystal alignment.

The photo-alignment polymer may be endowed with photo-alignment upon exposure to polarized UV radiation having a wavelength of about 150 to 450 nm. For example, the photo-alignment polymer can exhibit excellence in photo-alignment and alignment rate upon exposure to polarized UV radiation having a wavelength of about 200 to 400 nm, preferably about 250 to 315 nm. More specifically, the photo-alignment polymer can exhibit the above mentioned characteristics such as absorbance ratio (AR) and the like by the absorption of polarized UV radiation having a wavelength of 270 to 340 nm, preferably about 300 nm.

Meanwhile, the above-mentioned photo-alignment polymer including the repeating unit of Formula 3a or 3b may be prepared by the following method. The method of preparing the photo-alignment polymer according to an embodiment of the present invention may include the step of forming the repeating unit of Formula 3a by an addition polymerization reaction of a monomer represented by the following Formula 1 in the presence of a catalyst composition including a precatalyst containing a transition metal in Group 10 and a cocatalyst:

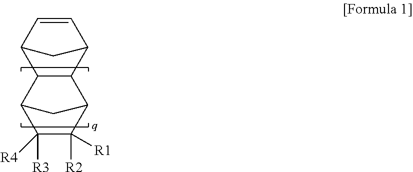

In formula 1, q, R1, R2, R3 and R4 are as defined in formula 3a.

In this case, the polymerization reaction may be carried out at a temperature of 10 to 200° C. When the reaction temperature is below 10° C., the polymerization activity may be lowered, and, when the reaction temperature is above 200° C., the catalyst may be decomposed, which is undesirable.

The cocatalyst includes at least one selected from the group consisting of a first cocatalyst providing a Lewis base capable of forming a weak coordinate bond with the metal of the precatalyst; and a second cocatalyst providing a compound including a Group 15 electron donor ligand. Preferably, the cocatalyst may be a catalyst mixture including the first cocatalyst providing a Lewis base, and optionally the second cocatalyst providing a compound including a neutral Group 15 electron donor ligand.

The catalyst mixture may include, based on one mole of the precatalyst, 1 to 1,000 moles of the first cocatalyst and 1 to 1,000 moles of the second cocatalyst. The excessively low content of the first or second cocatalyst causes a failure to provide the catalyst enough activity, while an excess of the first or second cocatalyst deteriorates the catalyst activity.

The precatalyst including a Group 10 transition metal may be a compound having a Lewis base functional group that is readily leaving from the central transition metal by the first cocatalyst providing a Lewis base and participating in a Lewis acid-base reaction to help the central transition metal change into a catalyst active species. The examples of the precatalyst include allylpalladium chloride dimer ([(Allyl)Pd(Cl)]₂), palladium(II) acetate ((CH₃CO₂)₂Pd), palladium(II) acetylacetonate ([CH₃COCH═C(O—)CH₃]₂Pd), NiBr(NP(CH₃)₃)₄, [PdCl(NB)O(CH₃)]₂, etc.

The first cocatalyst providing a Lewis base capable of forming a weak coordinate bond with the metal of the precatalyst may be a compound that readily reacts with a Lewis base to leave vacancies in the transition metal and forms a weak coordinate bond with a transition metal compound in order to stabilize the resultant transition metal; or a compound providing such a compound. The examples of the first cocatalyst may include borane (e.g., B(C₆F₅)₃), borate (e.g., dimethylanilinium tetrakis(pentafluorophenyl)borate), alkylaluminum (e.g., methylaluminoxane (MAO) or Al(C₂H₅)₃), transition metal halide (e.g., AgSbF₆), etc.

The examples of the second cocatalyst that provides a compound including a neutral Group 15 electron donor ligand may include alkyl phosphine, cycloalkyl phosphine, or phenyl phosphine.

The first and second cocatalysts may be used separately, or used together to form a single salt compound used as a compound for activating the catalyst. For example, there may be a compound prepared as an ion pair of alkyl phosphine and a borane or borate compound.

The above-described method may be used to prepare a repeating unit of Formula 3a and a photo-alignment polymer including the repeating unit. As for a photo-alignment polymer further including an olefin-, cyclic-olefin- or acrylate-based repeating unit, typical preparation methods are used for forming each of the corresponding repeating units, which is then copolymerized with the repeating unit of Formula 3a prepared by the above-described method to form the photo-alignment polymer.

Meanwhile, a photo-alignment polymer including a repeating unit of Formula 2a may be prepared according to another example of the preparation method. The another exemplary preparation method includes the step of performing a ring-opening polymerization using a monomer of Formula 1 in the presence of a catalyst composition including a precatalyst containing a transition metal in Group 4, 6 or 8, and a cocatalyst to form a repeating unit of Formula 3b. Alternatively, the photo-alignment polymer including a repeating unit of Formula 3b may be prepared by a method that includes the step of performing a ring-opening polymerization using norbornene (alkyl)ol, such as norbornene methanol, as a norbornene monomer in the presence of a catalyst composition including a precatalyst containing a transition metal in Group 4, 6 or 8, and a cocatalyst to form a ring-opened polymer with a 5-membered ring, and then introducing a photoreactive group on the ring-opened polymer to complete the photo-alignment polymer. Here, the introduction of the photoreactive group may be achieved using a condensation reaction of the ring-opened polymer with a carboxylate compound or an acyl chloride compound having a photoreactive group of Formula 1a or 1b.

The ring-opening polymerization step may involve hydrogenation of the double bond of the norbornene ring included in the monomer of Formula 1 to open the norbornene ring, simultaneously beginning a polymerization reaction to prepare a repeating unit of Formula 3b and a photo-alignment polymer including the repeating unit. Alternatively, polymerization and ring-opening reactions may occur in sequence to form the photo-alignment polymer.

The ring-opening polymerization may be carried out in the presence of a catalyst composition, which includes a precatalyst containing a transition metal in Group 4 (e.g., Ti, Zr, or Hf), Group 6 (e.g., Mo, or W) or Group 8 (e.g., Ru, or Os); a cocatalyst providing a Lewis base capable of forming a weak coordinate bond with the metal of the precatalyst; and optionally a neutral Group 15 or 16 activator for improving the activity of the metal in the precatalyst. In the presence of the catalyst composition, a linear alkene, such as 1-alkene, 2-alkene, etc., controllable in molecular weight is added in an amount of 1 to 100 mol % with respect to the monomer to catalyze a polymerization reaction at 10 to 200° C. Then, a catalyst including a transition metal in Group 4 (e.g., Ti, or Zr) or Groups 8 to 10 (e.g., Ru, Ni, or Pd) is added in an amount of 1 to 30 wt. % with respect to the monomer to catalyze a hydrogenation reaction on the double bond of the norbornene ring at 10 to 250° C.

The excessively lower reaction temperature deteriorates the polymerization activity, and the excessively higher reaction temperature results in an undesirable decomposition of the catalyst. The lower hydrogenation temperature deteriorates the reaction activity, while the excessively high hydrogenation temperature causes a decomposition of the catalyst.

The catalyst composition includes one mole of a precatalyst containing a transition metal in Group 4 (e.g., Ti, Zr, or Hf), Group 6 (e.g., Mo, or W) or Group 8 (e.g., Ru, or Os); 1 to 100,000 moles of a cocatalyst providing a Lewis base capable of forming a weak coordinate bond with the metal of the precatalyst; and optionally 1 to 100 moles of an activator including a neutral Group 15 or 16 element for improving the activity of the metal of the precatalyst.

The cocatalyst content less than one mole causes a failure in activation of the catalyst, and the cocatalyst content greater than 100,000 moles deteriorates the catalyst activity. The activator may be unnecessary depending on the type of the precatalyst. The activator content of less than one mole ends up with a failure of the catalyst activation, while the activator content of greater than 100 moles results in a lower molecular weight.

The hydrogenation reaction fails to occur when the content of the catalyst including a transition metal of Group 4 (e.g., Ti, or Zr) or Group 8, 9 or 10 (e.g., Ru, Ni, or Pd) for hydrogenation reaction is less than 1 wt. % with respect to the monomer. The catalyst content of greater than 30 wt % undesirably results in a discoloration of the polymer.

The precatalyst including a transition metal in Group 4 (e.g., Ti, Zr, or Hf), Group 6 (e.g., Mo, or W) or Group 8 (e.g., Ru, or Os) may refer to a transition metal compound, such as TiCl₄, WCl₆, MoCl₆, RuCl₃, or ZrCl₄, having a functional group that is readily leaving from the central transition metal by the first cocatalyst providing a Lewis base and participating in a Lewis acid-base reaction to help the central transition metal change into a catalyst active species.

The examples of the cocatalyst providing a Lewis base capable of forming a weak coordinate bond with the metal of the precatalyst may include borane, such as B((C₆F₅)₃, or borate; or alkylaluminum, alkylaluminum halide or aluminum halide, such as methylaluminoxane (MAO), Al(C₂H₅)₃, or Al(CH₃)Cl₂. Here, aluminum may be replaced by a substituent, such as lithium, magnesium, germanium, lead, zinc, tin, silicon, etc. Hence, the cocatalyst is a compound that readily reacts with a Lewis base to provide vacancies in the transition metal and forms a weak coordinate bond with the transition metal compound in order to stabilize the produced transition metal; or a compound providing such a compound.

A polymerization activator may be required depending on the type of the precatalyst. The examples of the activator including a neutral element in Group 15 or 16 may include water, methanol, ethanol, isopropyl alcohol, benzylalcohol, phenol, ethyl mercaptan, 2-chloroethanol, trimethylamine, triethylamine, pyridine, ethylene oxide, benzoyl peroxide, t-butyl peroxide, or the like.

The catalyst including a transition metal in Group 4 (e.g., Ti, or Zr) or Group 8, 9 or 10 (e.g., Ru, Ni, or Pd) used for hydrogenation reaction may be prepared as a homogeneous form miscible with a solvent, or as a metal complex catalyst impregnated on a particulate support. Preferably, the examples of the particulate support include silica, titania, silica/chromia, silica/chromia/titania, silica/alumina, aluminum phosphate gel, silanized silica, silica hydrogel, montmorillonite clay, or zeolite.

The above-described method is used to prepare the repeating unit of Formula 3b and the photo-alignment polymer including the repeating unit. As for the photo-alignment polymer that further includes an olefin-, cyclic-olefin- or acrylate-based repeating unit, the respective repeating units are first formed through the corresponding preparation methods and then copolymerized with the repeating unit of Formula 3b prepared by the above-described method to form the photo-alignment polymer.

In accordance with still another embodiment of the invention, there is provided an alignment layer including the above-described photo-alignment polymer. The alignment layer may be prepared in the form of a film or a thin film. In accordance with further another embodiment of the invention, there is provided a liquid crystal retardation film including the alignment layer and a liquid crystal layer formed on the alignment layer.

The alignment layer and the liquid crystal retardation film may be prepared using preparation methods and constituents known to those skilled in the art, except that they includes the above-mentioned photo-alignment polymer.

For example, the alignment layer is prepared by mixing the photo-alignment polymer with a binder resin and a photo-initiator, dissolving the mixture in an organic solvent to obtain a coating composition, applying the coating composition on a substrate and then curing the coating composition by UV exposure.

Here, the binder resin may be an acrylate-based resin, more specifically, pentaerythritol triarylate, dipentaerythritol hexaacrylate, tri methylolpropane triacrylate, tris(2-acryloyloxyethyl) isocyanurate, etc.

The photo-initiator may be any typical photo-initiator known to be applicable to alignment layers without limitation, such as, for example, Irgacure 907 or Irgacure 819.

The examples of the organic solvent may include toluene, anisole, chlorobenzene, dichloroethane, cyclohexane, cyclopentane, propylene glycol, methyl ether, acetate, etc. Other organic solvents may also be used without limitation, because the above-mentioned photo-alignment polymer has good solubility in various organic solvents.

In the coating composition, the content of the solid components including the photo-alignment polymer, the binder resin and the photo-initiator may be in the range of 1 to 15 wt %, preferably 10 to 15 wt % to cast the alignment layer into a film, or 1 to 5 wt % to cast the alignment layer into a thin film.

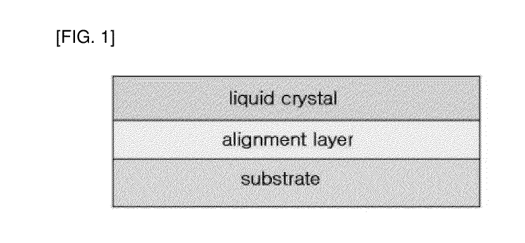

As shown in FIG. 1, the alignment layer may be formed on a substrate, and may be formed under liquid crystals to achieve liquid crystal alignment. Here, the substrate may be a cyclic polymer-containing substrate, an acryl polymer-containing substrate, or a cellulose polymer-containing substrate. The coating composition is applied on the substrate by different methods, such as bar coating, spin coating, blade coating, etc. and then cured under UV exposure to form an alignment layer.

The UV curing causes photo-alignment, in which step a polarized UV radiation having a wavelength of about 150 to 450 nm is applied to bring about alignment. Here, the exposure intensity of the UV radiation is about 50 mJ/cm² to 10 J/cm², preferably, about 500 mJ/cm² to 5 J/cm².

The UV radiation as used herein may be selected from among UV radiations polarized by passing through or being reflected from \textcircled{1} a polarizer using a dielectric anisotropic coating on the surface of a transparent substrate such as quartz glass, soda-lime glass, soda-lime-free glass, or the like; \textcircled{2} a polarizer with fine aluminum or other metallic wires; and \textcircled{3} a Brewster polarizer using reflection from quartz glass.

The substrate temperature during UV exposure is preferably the room temperature. Under circumstances, the substrate may be heated at 100° C. or below during UV exposure. Preferably, the final layer thus obtained from the above-described steps has a thickness of about 30 to 1,000 μm.

The liquid crystal retardation film may be prepared by forming an alignment layer on a substrate and then forming a liquid crystal layer on the alignment layer. This liquid crystal retardation film may be a patterned liquid crystal retardation film applied to the realization of three-dimensional images. In the patterned liquid crystal retardation film, the alignment layer may include two kinds of alignment layers including photo-alignment polymers having different alignment directions from each other, and the liquid crystal layer may be divided into two patterned regions. As described above, when the photo-alignment polymer according to an embodiment of the present invention is used, the patterned liquid crystal retardation film can be efficiently prepared through the first exposure of polarized UV radiation and the second exposure thereof using a single-mask process. In particular, this patterned liquid crystal retardation film can contribute to the realization of good three-dimensional images because its respective regions can exhibit excellent orientation.

The above-mentioned alignment layer or liquid crystal retardation film is applicable to optical films or filters for realizing three-dimensional images.

In accordance with still further another embodiment of the invention, there is provided a display device including the alignment layer or the liquid crystal retardation film. The display device may be a liquid crystal display device including the alignment layer for liquid crystal alignment, or may be a three-dimensional imaging display device included in an optical film or filter for realizing three-dimensional images. Since the constituents of the display device are the same as those of a typical display device, except that the display device includes the above-mentioned photo-alignment polymer and alignment layer, they will not be described any more in further detail.

### Examples

In the following are set forth preferred examples of the invention for better understanding of the invention. It is to be understood that the examples are only for illustrative purposes and are not intended to limit the scope of the invention.

### Example 1

### Preparation of 4-benzyloxy-cinnamate-5-norbornene (cyclic olefin compound)

4-Benzyloy-benzaldehyde (10 g, 47 mmol), malonic acid (2 eq.) and piperidine (0.1 eq.) were dissolved in pyridine (5 eq.) and stirred at 80° C. for 5 hours. After completion of the reaction, the reaction mixture was cooled down to the room temperature and neutralized with 3M HCl. The white solid thus obtained was filtered out and dried in a vacuum oven to yield 4-benzyloxy-cinnamic acid.

The 4-benzyloxy-cinnamic acid (5 g, 19.7 mmol), norbornene-5-ol (19 mmol) and Zr(AcAc) (0.2 mol. %) were put in xylene and stirred at 190° C. for 24 hours. Then, the reaction mixture was washed with 1M HCl and 1M NaHCO3 aqueous solutions and removed of the solvent to obtain a yellowish solid, 4-benzyloxy-cinnamate-5-norbornene.

NMR (CDCl₃ (500 MHz), ppm): 0.6 (1, m) 1.22˜1.27 (2, m) 1.47 (1, d) 1.87 (1, m) 2.56 (1, m) 2.93 (1, s) 5.11 (2, s) 5.98˜6.19 (2, m) 6.36 (1, d) 7.3˜7.5 (9, m) 7.63 (2, d).

### Example 2

### Preparation of 4-benzyloxy-cinnamate-5-methyl norbornene (cyclic olefin compound)

The procedures were performed in the same manner as described in Example 1, except that norbornene-5-methanol was used instead of norbornene-5-ol to prepare 4-benzyloxy-cinnamate-5-methyl norbornene.

NMR (CDCl₃ (500 MHz), ppm): 0.6 (1, m) 1.22˜1.27 (2, m) 1.47 (1, d) 1.87 (1, m) 2.47 (1, m) 2.93 (1, s) 3.8˜4.25 (2, m) 5.11 (2, s) 5.98˜6.19 (2, m) 6.36 (1, d) 7.3˜7.5 (9, m) 7.63 (2, d).

### Example 3

### Preparation of 4-benzyloxy-cinnamate-5-ethyl norbornene (cyclic olefin compound)

The procedures were performed in the same manner as described in Example 1, except that norbornene-5-ethanol was used instead of norbornene-5-ol to prepare 4-benzyloxy-cinnamate-5-ethyl norbornene.

NMR (CDCl₃ (500 MHz), ppm): 0.6 (1, m) 1.22˜1.27 (2, m) 1.33˜1.6 (3, m) 1.8 (1, m) 2.43 (1, m) 2.90 (1, s) 3.3˜3.9 (2, m) 5.11 (2, s) 5.95˜6.17 (2, m) 6.36 (1, d) 7.3˜7.5 (9, m) 7.63 (2, d).

### Example 4

### Preparation of 4-(4-fluoro-benzyloxy)-cinnamate-5-norbornene (cyclic olefin compound)

The procedures were performed in the same manner as described in Example 1, except that 4-(4-fluoro-benzyloxy)-benzaldehyde was used instead of 4-benzyloxy-benzaldehyde to prepare 4-(4-fluoro-benzyloxy)-cinnamate-5-norbornene.

NMR (CDCl₃ (500 MHz), ppm): 0.6 (1, m) 1.22˜1.27 (2, m) 1.47 (1, d) 1.88 (1, m) 2.67 (1, m) 2.93 (1, s) 5.05 (2, s) 5.97˜6.11 (2, m) 6.30 (1, d) 6.97 (2, d) 7.1 (2, m) 7.4 (2, m) 7.49 (2, d) 7.65 (1, s).

### Example 5

### Preparation of 4-(4-fluoro-benzyloxy)-cinnamate-5-methyl norbornene (cyclic olefin compound)

The procedures were performed in the same manner as described in Example 4, except that norbornene-5-methanol was used instead of norbornene-5-ol to prepare 4-(4-fluoro-benzyloxy)-cinnamate-5-methyl norbornene.

NMR (CDCl₃ (500 MHz), ppm): 0.6 (1, m) 1.22˜1.27 (2, m) 1.47 (1, d) 1.88 (1, m) 2.47 (1, m) 2.93 (1, s) 5.05 (2, s) 5.97˜6.11 (2, m) 6.30 (1, d) 6.97 (2, d) 7.1 (2, m) 7.4 (2, m) 7.49 (2, d) 7.65 (1, s).

### Example 6

### Preparation of 4-(4-fluoro-benzyloxy)-cinnamate-5-ethyl norbornene (cyclic olefin compound)

The procedures were performed in the same manner as described in Example 4, except that norbornene-5-ethanol was used instead of norbornene-5-ol to prepare 4-(4-fluoro-benzyloxy)-cinnamate-5-ethyl norbornene.

NMR (CDCl₃ (500 MHz), ppm): 0.6 (1, m) 1.22˜1.27 (2, m) 1.36˜1.6 (3, m) 1.86 (1, m) 2.45 (1, m) 2.91 (1, s) 3.32˜3.96 (2, m) 5.05 (2, s) 5.97˜6.11 (2, m) 6.30 (1, d) 6.97 (2, d) 7.1 (2, m) 7.4 (2, m) 7.49 (2, d) 7.65 (1, s).

### Example 7

### Preparation of 4-(4-methyl-benzyloxy)-cinnamate-5-norbornene (cyclic olefin compound)

The procedures were performed in the same manner as described in Example 1, except that 4-(4-methyl-benzyloxy)-benzaldehyde was used instead of 4-benzyloxy-benzaldehyde to prepare 4-(4-methyl-benzyloxy)-cinnamate-5-norbornene.

NMR (CDCl₃ (500 MHz), ppm): 0.6 (1, m) 1.21˜1.27 (2, m) 1.47 (1, d) 1.88 (1, m) 2.37 (3, s) 2.67 (1, m) 2.93 (1, s) 5.05 (2, s) 5.97˜6.11 (2, m) 6.30 (1, d) 6.97 (2, m) 7.1 (2, m) 7.4 (2, m) 7.45 (2, d) 7.65 (1, s).

### Example 8

### Preparation of 4-(4-methyl-benzyloxy)-cinnamate-5-methyl norbornene (cyclic olefin compound)

The procedures were performed in the same manner as described in Example 7, except that norbornene-5-methanol was used instead of norbornene-5-ol to prepare 4-(4-methyl-benzyloxy)-cinnamate-5-methyl norbornene.

NMR (CDCl₃ (500 MHz), ppm): 0.6 (1, m) 1.22˜1.27 (2, m) 1.47 (1, d) 1.88 (1, m) 2.37 (3, s) 2.47 (1, m) 2.93 (1, s) 3.74˜4.28 (2, m) 5.05 (2, s) 5.97˜6.11 (2, m) 6.30 (1, d) 6.97 (2, d) 7.1 (2, m) 7.4 (2, m) 7.47 (2, d) 7.65 (1, s).

### Example 9

### Preparation of 4-(4-methyl-benzyloxy)-cinnamate-5-ethyl norbornene (cyclic olefin compound)

The procedures were performed in the same manner as described in Example 7, except that norbornene-5-ethanol was used instead of norbornene-5-ol to prepare 4-(4-methyl-benzyloxy)-cinnamate-5-ethyl norbornene.

NMR (CDCl₃ (500 MHz), ppm): 0.6 (1, m) 1.22˜1.27 (2, m) 1.35˜1.6 (3, m) 1.86 (1, m) 2.37 (3, s) 2.45 (1, m) 2.91 (1, s) 3.33˜3.96 (2, m) 5.05 (2, s) 5.97˜6.11 (2, m) 6.30 (1, d) 6.97 (2, d) 7.1 (2, m) 7.4 (2, m) 7.49 (2, d) 7.65 (1, s).

### Example 10

### Preparation of 4-(4-methoxy-benzyloxy)-cinnamate-5-norbornene (cyclic olefin compound)

The procedures were performed in the same manner as described in Example 1, except that 4-(4-methoxy-benzyloxy)-benzaldehyde was used instead of 4-benzyloxy-benzaldehyde to prepare 4-(4-methoxy-benzyloxy)-cinnamate-5-norbornene.

NMR (CDCl₃ (500 MHz), ppm): 0.6 (1, m) 1.20˜1.27 (2, m) 1.47 (1, d) 1.88 (1, m) 2.67 (1, m) 2.93 (1, s) 4.44 (3, s) 5.05 (2, s) 5.98˜6.11 (2, m) 6.30 (1, d) 7.01 (2, d) 7.16 (2, m) 7.44 (2, m) 7.51 (2, d) 7.65 (1, s).

### Example 11

### Preparation of 4-(4-methoxy-benzyloxy)-cinnamate-5-methyl norbornene (cyclic olefin compound)

The procedures were performed in the same manner as described in Example 10, except that norbornene-5-methanol was used instead of norbornene-5-ol to prepare 4-(4-methoxy-benzyloxy)-cinnamate-5-methyl norbornene.

NMR (CDCl₃ (500 MHz), ppm): 0.6 (1, m) 1.22˜1.27 (2, m) 1.47 (1, d) 1.88 (1, m) 2.47 (1, m) 2.93 (1, s) 3.75˜4.3 (2, m) 5.05 (2, s) 5.97˜6.11 (2, m) 6.30 (1, d) 6.97 (2, d) 7.01 (2, d) 7.16 (2, m) 7.44 (2, m) 7.51 (2, d) 7.65 (1, s).

### Example 12

### Preparation of 4-(4-methoxy-benzyloxy)-cinnamate-5-ethyl norbornene (cyclic olefin compound)

The procedures were performed in the same manner as described in Example 10, except that norbornene-5-ethanol was used instead of norbornene-5-ol to prepare 4-(4-methoxy-benzyloxy)-cinnamate-5-ethyl norbornene.

NMR (CDCl₃ (500 MHz), ppm): 0.6 (1, m) 1.22˜1.27 (2, m) 1.33˜1.57 (3, m) 1.86 (1, m) 2.45 (1, m) 2.92 (1, s) 3.32˜3.96 (2, m) 5.05 (2, s) 5.97˜6.11 (2, m) 6.30 (1, d) 7.01 (2, d) 7.16 (2, m) 7.44 (2, m) 7.51 (2, d) 7.65 (1, s).

### Example 13

### Preparation of 4-(2-naphthalene-methyloxy)-cinnamate-5-norbornene (cyclic olefin compound)

The procedures were performed in the same manner as described in Example 1, except that 4-(2-naphthalene-methyloxy)-benzaldehyde was used instead of 4-benzyloxy-benzaldehyde to prepare 4-(2-naphthalene-methyloxy)-cinnamate-5-norbornene.

NMR (CDCl₃ (500 MHz), ppm): 0.6 (1, m) 1.22˜1.27 (2, m) 1.47 (1, d) 1.88 (1, m) 2.64 (1, m) 2.93 (1, s) 5.28 (2, s) 5.97˜6.11 (2, m) 6.31 (1, d) 6.63 (2, d) 7.5 (6, m) 7.9 (4, m).

### Example 14

### Preparation of 4-(2-naphthalene-methyloxy)-cinnamate-5-methyl norbornene (cyclic olefin compound)

The procedures were performed in the same manner as described in Example 13, except that norbornene-5-methanol was used instead of norbornene-5-ol to prepare 4-(2-naphthalene-methyloxy)-cinnamate-5-methyl norbornene.

NMR (CDCl₃ (500 MHz), ppm): 0.6 (1, m) 1.22˜1.27 (2, m) 1.47 (1, d) 1.88 (1, m) 2.48 (1, m) 2.91 (1, s) 3.75˜4.3 (2, m) 5.28 (2, s) 5.97˜6.11 (2, m) 6.31 (1, d) 6.63 (2, d) 7.5 (6, m) 7.9 (4, m).

### Example 15

### Preparation of 4-(2-naphthalene-methyloxy)-cinnamate-5-ethyl norbornene (cyclic olefin compound)

The procedures were performed in the same manner as described in Example 13, except that norbornene-5-ethanol was used instead of norbornene-5-ol to prepare 4-(2-naphthalene-methyloxy)-cinnamate-5-ethyl norbornene.

NMR (CDCl₃ (500 MHz), ppm): 0.6 (1, m) 1.21˜1.27 (2, m) 1.37˜1.6 (3, m) 1.86 (1, m) 2.45 (1, m) 2.90 (1, s) 3.62˜4.05 (2, m) 5.05 (2, s) 5.97˜6.11 (2, m) 6.31 (1, d) 6.63 (2, d) 7.5 (6, m) 7.9 (4, m).

### Example 16

### Preparation of 4-(4-methylketone benzyloxy)-cinnamate-5-norbornene (cyclic olefin compound)

The procedures were performed in the same manner as described in Example 1, except that 4-(4-methylketone benzyloxy)-benzaldehyde was used instead of 4-benzyloxy-benzaldehyde to prepare 4-(4-methylketone benzyloxy)-cinnamate-5-norbornene.

NMR (CDCl₃ (500 MHz), ppm): 0.6 (1, m) 1.22˜1.27 (2, m) 1.47 (1, d) 1.88 (1, m) 2.67 (1, m) 2.93 (1, s) 3.66 (3, s) 5.05 (2, s) 5.97˜6.11 (2, m) 6.27 (1, d) 7.0 (2, d) 7.1 (2, m) 7.4 (2, m) 7.50 (2, d) 7.65 (1, s).

### Example 17

### Preparation of 4-(4-methylketone benzyloxy)-cinnamate-5-methyl norbornene (cyclic olefin compound)

The procedures were performed in the same manner as described in Example 16, except that norbornene-5-methanol was used instead of norbornene-5-ol to prepare 4-(4-methylketone benzyloxy)-cinnamate-5-methyl norbornene.

NMR (CDCl₃ (500 MHz), ppm): 0.6 (1, m) 1.22˜1.27 (2, m) 1.47 (1, d) 1.87 (1, m) 2.47 (1, m) 2.93 (1, s) 3.66 (3, s) 3.8˜4.25 (2, m) 5.05 (2, s) 5.97˜6.11 (2, m) 6.27 (1, d) 7.0 (2, d) 7.1 (2, m) 7.4 (2, m) 7.50 (2, d) 7.65 (1, s).

### Example 18

### Preparation of 4-(4-methylketone benzyloxy)-cinnamate-5-ethyl norbornene (cyclic olefin compound)

The procedures were performed in the same manner as described in Example 16, except that norbornene-5-ethanol was used instead of norbornene-5-ol to prepare 4-(4-methylketone benzyloxy)-cinnamate-5-ethyl norbornene.

NMR (CDCl₃ (500 MHz), ppm): 0.6 (1, m) 1.24˜1.29 (2, m) 1.33˜1.6 (3, m) 1.8 (1, m) 2.43 (1, m) 2.90 (1, s) 3.66 (3, s) 3.8˜4.25 (2, m) 5.05 (2, s) 5.97˜6.11 (2, m) 6.27 (1, d) 7.0 (2, d) 7.1 (2, m) 7.4 (2, m) 7.50 (2, d) 7.65 (1, s).

### Example 19

### Preparation of 4-(1-phenyl perfluoroheptyloxy)-cinnamate-5-norbornene (cyclic olefin compound)

The procedures were performed in the same manner as described in Example 1, except that 4-(1-phenyl perfluoroheptyloxy)-benzaldehyde was used instead of 4-benzyloxy-benzaldehyde to prepare 4-(1-phenyl perfluoroheptyloxy)-cinnamate-5-norbornene.

NMR (CDCl₃ (500 MHz), ppm): 0.6 (1, m) 1.22˜1.27 (2, m) 1.47 (1, d) 1.87 (1, m) 2.56 (1, m) 2.93 (1, s) 5.10 (2, s) 5.96˜6.16 (2, m) 6.55 (1, d) 7.4˜7.55 (5, m) 7.65 (2, d) 7.68 (4, m).

### Example 20

### Preparation of 4-(1-phenyl perfluoroheptyloxy)-cinnamate-5-methyl norbornene (cyclic olefin compound)

The procedures were performed in the same manner as described in Example 19, except that norbornene-5-methanol was used instead of norbornene-5-ol to prepare 4-(1-phenyl perfluoroheptyloxy)-cinnamate-5-methyl norbornene.

NMR (CDCl₃ (500 MHz), ppm): 0.6 (1, m) 1.22˜1.27 (2, m) 1.47 (1, d) 1.87 (1, m) 2.56 (1, m) 2.93 (1, s) 3.75˜4.3 (2, m) 5.10 (2, s) 5.96˜6.16 (2, m) 6.55 (1, d) 7.4˜7.55 (5, m) 7.65 (2, d) 7.68 (4, m).

### Example 21

### Preparation of 4-(1-phenyl perfluoroheptyloxy)-cinnamate-5-ethyl norbornene (cyclic olefin compound)

The procedures were performed in the same manner as described in Example 19, except that norbornene-5-ethanol was used instead of norbornene-5-ol to prepare 4-(1-phenyl perfluoroheptyloxy)-cinnamate-5-ethyl norbornene.

NMR (CDCl₃ (500 MHz), ppm): 0.6 (1, m) 1.22˜1.27 (2, m) 1.34˜1.59 (3, m) 1.86 (1, m) 2.56 (1, m) 2.92 (1, s) 3.31˜3.96 (2, m) 5.10 (2, s) 5.96˜6.16 (2, m) 6.55 (1, d) 7.4˜7.55 (5, m) 7.65 (2, d) 7.68 (4, m).

### Example 22

### Preparation of 4-(4-benzyloxy)-benzyloxy-cinnamate-5-norbornene (cyclic olefin compound)

The procedures were performed in the same manner as described in Example 1, except that 4-(4-benzyloxy)-benzyloxy-benzaldehyde was used instead of 4-benzyloxy-benzaldehyde to prepare 4-(4-benzyloxy)-benzyloxy-cinnamate-5-norbornene.

NMR (CDCl₃ (500 MHz), ppm): 0.6 (1, m) 1.22˜1.27 (2, m) 1.47 (1, d) 1.88 (1, m) 2.67 (1, m) 2.93 (1, s) 5.16 (4, s) 5.97˜6.11 (2, m) 6.30 (1, d) 6.99˜7.15 (8, d) 7.4˜7.51 (5, d) 7.61 (1, s).

### Example 23

### Preparation of 4-(4-benzyloxy)-benzyloxy-cinnamate-5-methyl norbornene (cyclic olefin compound)

The procedures were performed in the same manner as described in Example 22, except that norbornene-5-methanol was used instead of norbornene-5-ol to prepare 4-(4-benzyloxy)-benzyloxy-cinnamate-5-methyl norbornene.

NMR (CDCl₃ (500 MHz), ppm): 0.6 (1, m) 1.22˜1.27 (2, m) 1.47 (1, d) 1.88 (1, m) 2.47 (1, m) 2.93 (1, s) 3.75˜4.3 (2, m) 5.16 (4, s) 5.97˜6.11 (2, m) 6.30 (1, d) 6.99˜7.15 (8, d) 7.4˜7.51 (5, d) 7.61 (1, s).

### Example 24

### Preparation of 4-(4-benzyloxy)-benzyloxy-cinnamate-5-ethyl norbornene (cyclic olefin compound)

The procedures were performed in the same manner as described in Example 22, except that norbornene-5-ethanol was used instead of norbornene-5-ol to prepare 4-(4-benzyloxy)-benzyloxy-cinnamate-5-ethyl norbornene.

NMR (CDCl₃ (500 MHz), ppm): 0.6 (1, m) 1.22˜1.27 (2, m) 1.36˜1.6 (3, m) 1.86 (1, m) 2.45 (1, m) 2.91 (1, s) 3.32˜3.96 (2, m) 5.16 (4, s) 5.97˜6.11 (2, m) 6.30 (1, d) 6.99˜7.15 (8, d) 7.4˜7.51 (5, d) 7.61 (1, s).

### Example 25

### Preparation of 4-(4-fluoro-phenyloxy)-benzyloxy-cinnamate-5-norbornene (cyclic olefin compound)

The procedures were performed in the same manner as described in Example 1, except that 4-(4-fluoro-phenyloxy)-benzyloxy-benzaldehyde was used instead of 4-benzyloxy-benzaldehyde to prepare 4-(4-fluoro-phenyloxy)-benzyloxy-cinnamate-5-norbornene.

NMR (CDCl₃ (500 MHz), ppm): 0.6 (1, m) 1.22˜1.27 (2, m) 1.47 (1, d) 1.88 (1, m) 2.55 (1, m) 2.91 (1, s) 5.08 (4, s) 5.91˜6.11 (2, m) 6.30 (1, d) 6.97 (2, d) 7.20 (2, m) 7.31˜7.63 (8, m) 7.68 (1, s) 7.84 (2, d).

### Example 26

### Preparation of 4-(4-fluoro-phenyloxy)-benzyloxy-cinnamate-5-methyl norbornene (cyclic olefin compound)

The procedures were performed in the same manner as described in Example 25, except that norbornene-5-methanol was used instead of norbornene-5-ol to prepare 4-(4-fluoro-phenyloxy)-benzyloxy-cinnamate-5-methyl norbornene.

NMR (CDCl₃ (500 MHz), ppm): 0.6 (1, m) 1.22˜1.27 (2, m) 1.47 (1, d) 1.88 (1, m) 2.55 (1, m) 2.92 (1, s) 3.75˜4.3 (2, m) 5.08 (4, s) 5.91˜6.11 (2, m) 6.30 (1, d) 6.97 (2, d) 7.20 (2, m) 7.31˜7.63 (8, m) 7.68 (1, s) 7.84 (2, d).

### Example 27

### Preparation of 4-(4-fluoro-phenyloxy)-benzyloxy-cinnamate-5-ethyl norbornene (cyclic olefin compound)

The procedures were performed in the same manner as described in Example 25, except that norbornene-5-ethanol was used instead of norbornene-5-ol to prepare 4-(4-fluoro-phenyloxy)-benzyloxy-cinnamate-5-ethyl norbornene.

NMR (CDCl₃ (500 MHz), ppm): 0.6 (1, m) 1.22˜1.27 (2, m) 1.36˜1.6 (3, m) 1.86 (1, m) 2.55 (1, m) 2.92 (1, s) 3.32˜3.96 (2, m) 5.08 (4, s) 5.91˜6.11 (2, m) 6.30 (1, d) 6.97 (2, d) 7.20 (2, m) 7.31˜7.63 (8, m) 7.68 (1, s) 7.84 (2, d).

### Example 28

### Preparation of 4-(4-trifluoromethyl)-benzyloxy-cinnamate-5-norbornene (cyclic olefin compound)

The procedures were performed in the same manner as described in Example 1, except that 4-(4-trifluoromethyl)-benzyloxy-benzaldehyde was used instead of 4-benzyloxy-benzaldehyde to prepare 4-(4-trifluoromethyl)-benzyloxy-cinnamate-5-norbornene.

NMR (CDCl₃ (500 MHz), ppm): 0.6 (1, m) 1.22˜1.27 (2, m) 1.47 (1, d) 1.88 (1, m) 2.67 (1, m) 2.93 (1, s) 5.05 (2, s) 5.97˜6.11 (2, m) 6.30 (1, d) 7.11˜7.25 (4, m) 7.4 (2, m) 7.60˜7.68 (3, m).

### Example 29

### Preparation of 4-(4-trifluoromethyl)-benzyloxy-cinnamate-5-methyl norbornene (cyclic olefin compound)

The procedures were performed in the same manner as described in Example 28, except that norbornene-5-methanol was used instead of norbornene-5-ol to prepare 4-(4-trifluoromethyl)-benzyloxy-cinnamate-5-methyl norbornene.

NMR (CDCl₃ (500 MHz), ppm): 0.6 (1, m) 1.22˜1.27 (2, m) 1.47 (1, d) 1.88 (1, m) 2.47 (1, m) 2.93 (1, s) 3.74˜4.28 (2, m) 5.05 (2, s) 5.97˜6.11 (2, m) 6.30 (1, d) 7.11˜7.25 (4, m) 7.4 (2, m) 7.60˜7.68 (3, m).

### Example 30

### Preparation of 4-(4-trifluoromethyl)-benzyloxy-cinnamate-5-ethyl norbornene (cyclic olefin compound)

The procedures were performed in the same manner as described in Example 28, except that norbornene-5-ethanol was used instead of norbornene-5-ol to prepare 4-(4-trifluoromethyl)-benzyloxy-cinnamate-5-ethyl norbornene.

NMR (CDCl₃ (500 MHz), ppm): 0.6 (1, m) 1.22˜1.27 (2, m) 1.36˜1.6 (3, m) 1.86 (1, m) 2.45 (1, m) 2.91 (1, s) 3.32˜3.96 (2, m) 5.05 (2, s) 5.97˜6.11 (2, m) 6.30 (1, d) 7.11˜7.25 (4, m) 7.4 (2, m) 7.60˜7.68 (3, m).

### Example 31

### Preparation of 4-(4-bromo-benzyloxy)-cinnamate-5-norbornene (cyclic olefin compound)

The procedures were performed in the same manner as described in Example 1, except that 4-(4-bromo-benzyloxy)-benzaldehyde was used instead of 4-benzyloxy-benzaldehyde to prepare 4-(4-bromo-benzyloxy)-cinnamate-5-norbornene.

NMR (CDCl₃ (500 MHz), ppm): 0.6 (1, m) 1.22˜1.27 (2, m) 1.47 (1, d) 1.88 (1, m) 2.67 (1, m) 2.93 (1, s) 5.05 (2, s) 5.97˜6.11 (2, m) 6.30 (1, d) 6.97 (2, d) 7.1 (2, m) 7.30 (2, m) 7.45 (2, d) 7.61 (1, s).

### Example 32

### Preparation of 4-(4-bromo-benzyloxy)-cinnamate-5-methyl norbornene (cyclic olefin compound)

The procedures were performed in the same manner as described in Example 31, except that norbornene-5-methanol was used instead of norbornene-5-ol to prepare 4-(4-bromo-benzyloxy)-cinnamate-5-methyl norbornene.

NMR (CDCl₃ (500 MHz), ppm): 0.6 (1, m) 1.22˜1.27 (2, m) 1.47 (1, d) 1.88 (1, m) 2.47 (1, m) 2.93 (1, s) 3.75˜4.3 (2, m) 5.05 (2, s) 5.97˜6.11 (2, m) 6.30 (1, d) 6.97 (2, d) 7.1 (2, m) 7.30 (2, m) 7.45 (2, d) 7.61 (1, s).

### Example 33

### Preparation of 4-(4-bromo-benzyloxy)-cinnamate-5-ethyl norbornene (cyclic olefin compound)

The procedures were performed in the same manner as described in Example 31, except that norbornene-5-ethanol was used instead of norbornene-5-ol to prepare 4-(4-bromo-benzyloxy)-cinnamate-5-ethyl norbornene.

NMR (CDCl₃ (500 MHz), ppm): 0.6 (1, m) 1.22˜1.27 (2, m) 1.36˜1.6 (3, m) 1.86 (1, m) 2.45 (1, m) 2.91 (1, s) 3.32˜3.96 (2, m) 5.05 (2, s) 5.97˜6.11 (2, m) 6.30 (1, d) 6.97 (2, d) 7.1 (2, m) 7.30 (2, m) 7.45 (2, d) 7.61 (1, s).

### Example 34

### Polymerization of 4-benzyloxy-cinnamate-5-norbornene

In a 250 ml Schlenk flask were placed 4-benzyloxy-cinnamate-5-norbornene (50 mmol) of Example 1 as a monomer, and purified toluene (400 wt %) as a solvent. 1-octene (10 mol. %) was also added. Under agitation, the mixture was heated to 90° C. To the flask were added Pd(OAc)₂ (16 μmol) and tricyclohexylphosphine (32 μmol) in 1 ml of dichloromethane as a catalyst, and dimethylanilinium tetrakiss(pentafluorophenyl)borate (32 μmol) as a cocatalyst. The mixture was stirred at 90° C. for 16 hours to bring about a reaction.

After completion of the reaction, the reactant mixture was put in an excess of ethanol to obtain a white polymer precipitate. The precipitate was filtered out through a glass funnel to collect a polymer, which was then dried in a vacuum oven at 60° C. for 24 hours to yield a final polymer product (Mw=198k, PDI=3.22, yield=68%).

### Example 35

### Polymerization of 4-benzyloxy-cinnamate-5-methyl norbornene

The procedures were performed in the same manner as described in Example 34, except that 4-benzyloxy-cinnamate-5-methyl norbornene (50 mmol) of Example 2 was used as a monomer instead of 4-benzyloxy-cinnamate-5-norbornene of Example 1 to obtain a polymer product (Mw=162k, PDI=3.16, yield=81%).

### Example 36

### Polymerization of 4-benzyloxy-cinnamate-5-ethyl norbornene

The procedures were performed in the same manner as described in Example 34, except that 4-benzyloxy-cinnamate-5-ethyl norbornene (50 mmol) of Example 3 was used as a monomer instead of 4-benzyloxy-cinnamate-5-norbornene of Example 1 to obtain a polymer product (Mw=159k, PDI=4.10, yield=80%).

### Example 37

### Polymerization of 4-(4-fluoro-benzyloxy)-cinnamate-5-norbornene

The procedures were performed in the same manner as described in Example 34, except that 4-(4-fluoro-benzyloxy)-cinnamate-5-norbornene (50 mmol) of Example 4 was used as a monomer instead of 4-benzyloxy-cinnamate-5-norbornene of Example 1 to obtain a polymer product (Mw=121 k, PDI=3.52, yield=62%).

### Example 38

### Polymerization of 4-(4-fluoro-benzyloxy)-cinnamate-5-methyl norbornene

The procedures were performed in the same manner as described in Example 34, except that 4-(4-fluoro-benzyloxy)-cinnamate-5-methyl norbornene (50 mmol) of Example 5 was used as a monomer instead of 4-benzyloxy-cinnamate-5-norbornene of Example 1 to obtain a polymer product (Mw=135k, PDI=2.94, yield=82%).

### Example 39

### Polymerization of 4-(4-fluoro-benzyloxy)-cinnamate-5-ethyl norbornene

The procedures were performed in the same manner as described in Example 34, except that 4-(4-fluoro-benzyloxy)-cinnamate-5-ethyl norbornene (50 mmol) of Example 6 was used as a monomer instead of 4-benzyloxy-cinnamate-5-norbornene of Example 1 to obtain a polymer product (Mw=144k, PDI=4.03, yield=74%).

### Example 40

### Polymerization of 4-(4-methyl-benzyloxy)-cinnamate-5-norbornene

The procedures were performed in the same manner as described in Example 34, except that 4-(4-methyl-benzyloxy)-cinnamate-5-norbornene (50 mmol) of Example 7 was used as a monomer instead of 4-benzyloxy-cinnamate-5-norbornene of Example 1 to obtain a polymer product (Mw=111 k, PDI=3.56, yield=58%).

### Example 41

### Polymerization of 4-(4-methyl-benzyloxy)-cinnamate-5-methyl norbornene

The procedures were performed in the same manner as described in Example 34, except that 4-(4-methyl-benzyloxy)-cinnamate-5-methyl norbornene (50 mmol) of Example 8 was used as a monomer instead of 4-benzyloxy-cinnamate-5-norbornene of Example 1 to obtain a polymer product (Mw=134k, PDI=3.71, yield=75%).

### Example 42

### Polymerization of 4-(4-methyl-benzyloxy)-cinnamate-5-ethyl norbornene

The procedures were performed in the same manner as described in Example 34, except that 4-(4-methyl-benzyloxy)-cinnamate-5-ethyl norbornene (50 mmol) of Example 9 was used as a monomer instead of 4-benzyloxy-cinnamate-5-norbornene of Example 1 to obtain a polymer product (Mw=130k, PDI=4.00, yield=71%).

### Example 43

### Polymerization of 4-(4-methoxy-benzyloxy)-cinnamate-5-norbornene

The procedures were performed in the same manner as described in Example 34, except that 4-(4-methoxy-benzyloxy)-cinnamate-5-norbornene (50 mmol) of Example 10 was used as a monomer instead of 4-benzyloxy-cinnamate-5-norbornene of Example 1 to obtain a polymer product (Mw=146k, PDI=3.42, yield=74%).

### Example 44

### Polymerization of 4-(4-methoxy-benzyloxy)-cinnamate-5-methyl norbornene

The procedures were performed in the same manner as described in Example 34, except that 4-(4-methoxy-benzyloxy)-cinnamate-5-methyl norbornene (50 mmol) of Example 11 was used as a monomer instead of 4-benzyloxy-cinnamate-5-norbornene of Example 1 to obtain a polymer product (Mw=144k, PDI=3.04, yield=79%).

### Example 45

### Polymerization of 4-(4-methoxy-benzyloxy)-cinnamate-5-ethyl norbornene

The procedures were performed in the same manner as described in Example 34, except that 4-(4-methoxy-benzyloxy)-cinnamate-5-ethyl norbornene (50 mmol) of Example 12 was used as a monomer instead of 4-benzyloxy-cinnamate-5-norbornene of Example 1 to obtain a polymer product (Mw=123k, PDI=3.69, yield=71%).

### Example 46

### Polymerization of 4-(2-naphthalene-methyloxy)-cinnamate-5-norbornene

The procedures were performed in the same manner as described in Example 34, except that 4-(2-naphthalene-methyloxy)-cinnamate-5-norbornene (50 mmol) of Example 13 was used as a monomer instead of 4-benzyloxy-cinnamate-5-norbornene of Example 1 to obtain a polymer product (Mw=91 k, PDI=4.01, yield=54%).

### Example 47

### Polymerization of 4-(2-naphthalene-methyloxy)-cinnamate-5-methyl norbornene

The procedures were performed in the same manner as described in Example 34, except that 4-(2-naphthalene-methyloxy)-cinnamate-5-methyl norbornene (50 mmol) of Example 14 was used as a monomer instead of 4-benzyloxy-cinnamate-5-norbornene of Example 1 to obtain a polymer product (Mw=83k, PDI=3.97, yield=61%).

### Example 48

### Polymerization of 4-(2-naphthalene-methyloxy)-cinnamate-5-ethyl norbornene

The procedures were performed in the same manner as described in Example 34, except that 4-(2-naphthalene-methyloxy)-cinnamate-5-ethyl norbornene (50 mmol) of Example 15 was used as a monomer instead of 4-benzyloxy-cinnamate-5-norbornene of Example 1 to obtain a polymer product (Mw=102k, PDI=3.72, yield=43%).

### Example 49

### Polymerization of 4-(4-methylketone benzyloxy)-cinnamate-5-norbornene

The procedures were performed in the same manner as described in Example 34, except that 4-(4-methylketone benzyloxy)-cinnamate-5-norbornene (50 mmol) of Example 16 was used as a monomer instead of 4-benzyloxy-cinnamate-5-norbornene of Example 1 to obtain a polymer product (Mw=109k, PDI=4.23, yield=47%).

### Example 50

### Polymerization of 4-(4-methylketone benzyloxy)-cinnamate-5-methyl norbornene

The procedures were performed in the same manner as described in Example 34, except that 4-(4-methylketone benzyloxy)-cinnamate-5-methyl norbornene (50 mmol) of Example 17 was used as a monomer instead of 4-benzyloxy-cinnamate-5-norbornene of Example 1 to obtain a polymer product (Mw=111k, PDI=4.21, yield=51%).

### Example 51

### Polymerization of 4-(4-methylketone benzyloxy)-cinnamate-5-ethyl norbornene

The procedures were performed in the same manner as described in Example 34, except that 4-(4-methylketone benzyloxy)-cinnamate-5-ethyl norbornene (50 mmol) of Example 18 was used as a monomer instead of 4-benzyloxy-cinnamate-5-norbornene of Example 1 to obtain a polymer product (Mw=87k, PDI=3.32, yield=43%).

### Example 52

### Polymerization of 4-(1-phenyl perfluoroheptyloxy)-cinnamate-5-norbornene

The procedures were performed in the same manner as described in Example 34, except that 4-(1-phenyl perfluoroheptyloxy)-cinnamate-5-norbornene (50 mmol) of Example 19 was used as a monomer instead of 4-benzyloxy-cinnamate-5-norbornene of Example 1 to obtain a polymer product (Mw=116k, PDI=3.09, yield=57%).

### Example 53

### Polymerization of 4-(1-phenyl perfluoroheptyloxy)-cinnamate-5-methyl norbornene

The procedures were performed in the same manner as described in Example 34, except that 4-(1-phenyl perfluoroheptyloxy)-cinnamate-5-methyl norbornene (50 mmol) of Example 20 was used as a monomer instead of 4-benzyloxy-cinnamate-5-norbornene of Example 1 to obtain a polymer product (Mw=105k, PDI=3.88, yield=69%).

### Example 54

### Polymerization of 4-(1-phenyl perfluoroheptyloxy)-cinnamate-5-ethyl norbornene

The procedures were performed in the same manner as described in Example 34, except that 4-(1-phenyl perfluoroheptyloxy)-cinnamate-5-ethyl norbornene (50 mmol) of Example 21 was used as a monomer instead of 4-benzyloxy-cinnamate-5-norbornene of Example 1 to obtain a polymer product (Mw=87k, PDI=4.62, yield=51%).

### Example 55

### Polymerization of 4-(4-benzyloxy)-benzyloxy-cinnamate-5-norbornene

The procedures were performed in the same manner as described in Example 34, except that 4-(4-benzyloxy)-benzyloxy-cinnamate-5-norbornene (50 mmol) of Example 22 was used as a monomer instead of 4-benzyloxy-cinnamate-5-norbornene of Example 1 to obtain a polymer product (Mw=137k, PDI=3.19, yield=68%).

### Example 56

### Polymerization of 4-(4-benzyloxy)-benzyloxy-cinnamate-5-methyl norbornene

The procedures were performed in the same manner as described in Example 34, except that 4-(4-benzyloxy)-benzyloxy-cinnamate-5-methyl norbornene (50 mmol) of Example 23 was used as a monomer instead of 4-benzyloxy-cinnamate-5-norbornene of Example 1 to obtain a polymer product (Mw=121k, PDI=3.52, yield=74%).

### Example 57

### Polymerization of 4-(4-benzyloxy)-benzyloxy-cinnamate-5-ethyl norbornene

The procedures were performed in the same manner as described in Example 34, except that 4-(4-benzyloxy)-benzyloxy-cinnamate-5-ethyl norbornene (50 mmol) of Example 24 was used as a monomer instead of 4-benzyloxy-cinnamate-5-norbornene of Example 1 to obtain a polymer product (Mw=130k, PDI=4.67, yield=63%).

### Example 58

### Polymerization of 4-(4-fluoro-phenyloxy)-benzyloxy-cinnamate-5-norbornene

The procedures were performed in the same manner as described in Example 34, except that 4-(4-fluoro-phenyloxy)-benzyloxy-cinnamate-5-norbornene (50 mmol) of Example 25 was used as a monomer instead of 4-benzyloxy-cinnamate-5-norbornene of Example 1 to obtain a polymer product (Mw=154k, PDI=3.22, yield=72%).

### Example 59

### Polymerization of 4-(4-fluoro-phenyloxy)-benzyloxy-cinnamate-5-methyl norbornene

The procedures were performed in the same manner as described in Example 34, except that 4-(4-fluoro-phenyloxy)-benzyloxy-cinnamate-5-methyl norbornene (50 mmol) of Example 26 was used as a monomer instead of 4-benzyloxy-cinnamate-5-norbornene of Example 1 to obtain a polymer product (Mw=148k, PDI=3.61, yield=73%).

### Example 60

### Polymerization of 4-(4-fluoro-phenyloxy)-benzyloxy-cinnamate-5-ethyl norbornene

The procedures were performed in the same manner as described in Example 34, except that 4-(4-fluoro-phenyloxy)-benzyloxy-cinnamate-5-ethyl norbornene (50 mmol) of Example 27 was used as a monomer instead of 4-benzyloxy-cinnamate-5-norbornene of Example 1 to obtain a polymer product (Mw=116k, PDI=4.17, yield=68%).

### Example 61

### Polymerization of 4-(4-trifluoromethyl)-benzyloxy-cinnamate-5-norbornene

The procedures were performed in the same manner as described in Example 34, except that 4-(4-trifluoromethyl)-benzyloxy-cinnamate-5-norbornene (50 mmol) of Example 28 was used as a monomer instead of 4-benzyloxy-cinnamate-5-norbornene of Example 1 to obtain a polymer product (Mw=133k, PDI=3.10, yield=44%).

### Example 62

### Polymerization of 4-(4-trifluoromethyl)-benzyloxy-cinnamate-5-methyl norbornene

The procedures were performed in the same manner as described in Example 34, except that 4-(4-trifluoromethyl)-benzyloxy-cinnamate-5-methyl norbornene (50 mmol) of Example 29 was used as a monomer instead of 4-benzyloxy-cinnamate-5-norbornene of Example 1 to obtain a polymer product (Mw=121k, PDI=3.38, yield=48%).

### Example 63

### Polymerization of 4-(4-trifluoromethyl)-benzyloxy-cinnamate-5-ethyl norbornene

The procedures were performed in the same manner as described in Example 34, except that 4-(4-trifluoromethyl)-benzyloxy-cinnamate-5-ethyl norbornene (50 mmol) of Example 30 was used as a monomer instead of 4-benzyloxy-cinnamate-5-norbornene of Example 1 to obtain a polymer product (Mw=127k, PDI=3.32, yield=41%).

### Example 64

### Polymerization of 4-(4-bromo-benzyloxy)-cinnamate-5-norbornene

The procedures were performed in the same manner as described in Example 34, except that 4-(4-bromo-benzyloxy)-cinnamate-5-norbornene (50 mmol) of Example 31 was used as a monomer instead of 4-benzyloxy-cinnamate-5-norbornene of Example 1 to obtain a polymer product (Mw=168k, PDI=3.06, yield=74%).

### Example 65

### Polymerization of 4-(4-bromo-benzyloxy)-cinnamate-5-methyl norbornene

The procedures were performed in the same manner as described in Example 34, except that 4-(4-bromo-benzyloxy)-cinnamate-5-methyl norbornene (50 mmol) of Example 32 was used as a monomer instead of 4-benzyloxy-cinnamate-5-norbornene of Example 1 to obtain a polymer product (Mw=160k, PDI=3.24, yield=83%).

### Example 66

### Polymerization of 4-(4-bromo-benzyloxy)-cinnamate-5-ethyl norbornene

The procedures were performed in the same manner as described in Example 34, except that 4-(4-bromo-benzyloxy)-cinnamate-5-ethyl norbornene (50 mmol) of Example 33 was used as a monomer instead of 4-benzyloxy-cinnamate-5-norbornene of Example 1 to obtain a polymer product (Mw=146k, PDI=3.52, yield=72%).

### Example 67

### Polymer Preparation Using Ring-Opening Metathesis Polymerization and Hydrogenation of 4-Benzyloxy-Cinnamate-5-Norbornene

In a 250 ml Schlenk flask in the an Ar atmosphere were placed 4-benzyloxy-cinnamate-5-norbornene (50 mmol) and then purified toluene (600 wt %) as a solvent. With the flask maintained at a polymerization temperature of 80° C., triethyl aluminum (1 mmol) was added as a cocatalyst. Subsequently, to the flask was added 1 ml (WCl₈: 0.01 mmol, ethanol: 0.03 mmol) of a 0.01 M (mol/L) toluene solution containing a mixture of tungsten hexachloride (WCl₈) and ethanol at a mixing ratio of 1:3. Finally, 1-octene (15 mol. %) was added as a molecular weight modifier to the flask, which was then stirred at 80° C. for 18 hours to bring about a reaction. After completion of the reaction, a small amount of ethyl vinyl ether as a polymerization inhibitor was added dropwise to the polymerization solution, and the flask was stirred for 5 minutes.

With the polymerization solution transferred to a 300 mL high-pressure reactor, 0.06 ml of triethyl aluminum (TEA) was added to the solution. Subsequently, 0.50 g of grace raney nickel (slurry phase in water) was added, and the solution was stirred at 150° C. for 2 hours under the hydrogen pressure maintained at 80 atm to bring about a reaction. After completion of the reaction, the polymerization solution was added dropwise to acetone to cause precipitation. The precipitate thus obtained was filtered out and dried in a vacuum oven at 70° C. for 15 hours, thereby obtaining a ring-opened hydrogenated polymer of 4-benzyloxy-cinnamate-5-norbornene (Mw=83k, PDI=4.92, yield=88%).

### Example 68

### Polymer Preparation Using Ring-Opening Metathesis Polymerization and Hydrogenation of 4-Benzyloxy-Cinnamate-5-Methyl Norbornene

The procedures were performed in the same manner as described in Example 67, except that 4-benzyloxy-cinnamate-5-methyl norbornene (50 mmol) of Example 2 was used as a monomer instead of 4-benzyloxy-cinnamate-5-norbornene of Example 1 to form a polymer (Mw=87k, PDI=4.22, yield=87%).

### Example 69

### Polymer Preparation Using Ring-Opening Metathesis Polymerization and Hydrogenation of 4-Benzyloxy-Cinnamate-5-Ethyl Norbornene

The procedures were performed in the same manner as described in Example 67, except that 4-benzyloxy-cinnamate-5-ethyl norbornene (50 mmol) of Example 3 was used as a monomer instead of 4-benzyloxy-cinnamate-5-norbornene of Example 1 to form a polymer (Mw=71k, PDI=4.18, yield=80%).

### Example 70

### Polymer Preparation Using Ring-Opening Metathesis Polymerization and Hydrogenation of 4-(4-Fluoro-Benzyloxy)-Cinnamate-5-Norbornene

The procedures were performed in the same manner as described in Example 67, except that 4-(4-fluoro-benzyloxy)-cinnamate-5-norbornene (50 mmol) of Example 4 was used as a monomer instead of 4-benzyloxy-cinnamate-5-norbornene of Example 1 to form a polymer (Mw=90k, PDI=3.40, yield=71%).

### Example 71

### Polymer Preparation Using Ring-Opening Metathesis Polymerization and Hydrogenation of 4-(4-Fluoro-Benzyloxy)-Cinnamate-5-Methyl Norbornene

The procedures were performed in the same manner as described in Example 67, except that 4-(4-fluoro-benzyloxy)-cinnamate-5-methyl norbornene (50 mmol) of Example 5 was used as a monomer instead of 4-benzyloxy-cinnamate-5-norbornene of Example 1 to form a polymer (Mw=87k, PDI=3.98, yield=76%).

### Example 72

### Polymer Preparation Using Ring-Opening Metathesis Polymerization and Hydrogenation of 4-(4-Fluoro-Benzyloxy)-Cinnamate-5-Ethyl Norbornene

The procedures were performed in the same manner as described in Example 67, except that 4-(4-fluoro-benzyloxy)-cinnamate-5-ethyl norbornene (50 mmol) of Example 6 was used as a monomer instead of 4-benzyloxy-cinnamate-5-norbornene of Example 1 to form a polymer (Mw=68k, PDI=3.51, yield=74%).

### Example 73

### Polymer Preparation Using Ring-Opening Metathesis Polymerization and Hydrogenation of 4-(4-Methyl-Benzyloxy)-Cinnamate-5-Norbornene

The procedures were performed in the same manner as described in Example 67, except that 4-(4-methyl-benzyloxy)-cinnamate-5-norbornene (50 mmol) of Example 7 was used as a monomer instead of 4-benzyloxy-cinnamate-5-norbornene of Example 1 to form a polymer (Mw=69k, PDI=4.13, yield=77%).

### Example 74

### Polymer Preparation Using Ring-Opening Metathesis Polymerization and Hydrogenation of 4-(4-Methyl-Benzyloxy)-Cinnamate-5-Methyl Norbornene

The procedures were performed in the same manner as described in Example 67, except that 4-(4-methyl-benzyloxy)-cinnamate-5-methyl norbornene (50 mmol) of Example 8 was used as a monomer instead of 4-benzyloxy-cinnamate-5-norbornene of Example 1 to form a polymer (Mw=81k, PDI=3.49, yield=84%).

### Example 75

### Polymer Preparation Using Ring-Opening Metathesis Polymerization and Hydrogenation of 4-(4-Methyl-Benzyloxy)-Cinnamate-5-Ethyl Norbornene

The procedures were performed in the same manner as described in Example 67, except that 4-(4-methyl-benzyloxy)-cinnamate-5-ethyl norbornene (50 mmol) of Example 9 was used as a monomer instead of 4-benzyloxy-cinnamate-5-norbornene of Example 1 to form a polymer (Mw=55k, PDI=5.37, yield=68%).

### Example 76

### Polymer Preparation Using Ring-Opening Metathesis Polymerization and Hydrogenation of 4-(4-Methoxy-Benzyloxy)-Cinnamate-5-Norbornene

The procedures were performed in the same manner as described in Example 67, except that 4-(4-methoxy-benzyloxy)-cinnamate-5-norbornene (50 mmol) of Example 10 was used as a monomer instead of 4-benzyloxy-cinnamate-5-norbornene of Example 1 to form a polymer (Mw=88k, PDI=3.56, yield=84%).

### Example 77

### Polymer Preparation Using Ring-Opening Metathesis Polymerization and Hydrogenation of 4-(4-Methoxy-Benzyloxy)-Cinnamate-5-Methyl Norbornene

The procedures were performed in the same manner as described in Example 67, except that 4-(4-methoxy-benzyloxy)-cinnamate-5-methyl norbornene (50 mmol) of Example 11 was used as a monomer instead of 4-benzyloxy-cinnamate-5-norbornene of Example 1 to form a polymer (Mw=81k, PDI=3.14, yield=80%).

### Example 78

### Polymer Preparation Using Ring-Opening Metathesis Polymerization and Hydrogenation of 4-(4-Methoxy-Benzyloxy)-Cinnamate-5-Ethyl Norbornene

The procedures were performed in the same manner as described in Example 67, except that 4-(4-methoxy-benzyloxy)-cinnamate-5-ethyl norbornene (50 mmol) of Example 12 was used as a monomer instead of 4-benzyloxy-cinnamate-5-norbornene of Example 1 to form a polymer (Mw=84k, PDI=3.90, yield=73%).

### Example 79

### Polymer Preparation Using Ring-Opening Metathesis Polymerization and Hydrogenation of 4-(2-Naphthalene-Methyloxy)-Cinnamate-5-Norbornene

The procedures were performed in the same manner as described in Example 67, except that 4-(2-naphthalene-methyloxy)-cinnamate-5-norbornene (50 mmol) of Example 13 was used as a monomer instead of 4-benzyloxy-cinnamate-5-norbornene of Example 1 to form a polymer (Mw=49k, PDI=4.53, yield=55%).

### Example 80

### Polymer Preparation Using Ring-Opening Metathesis Polymerization and Hydrogenation of 4-(2-Naphthalene-Methyloxy)-Cinnamate-5-Methyl Norbornene

The procedures were performed in the same manner as described in Example 67, except that 4-(2-naphthalene-methyloxy)-cinnamate-5-methyl norbornene (50 mmol) of Example 14 was used as a monomer instead of 4-benzyloxy-cinnamate-5-norbornene of Example 1 to form a polymer (Mw=53k, PDI=3.91, yield=51%).

### Example 81

### Polymer Preparation Using Ring-Opening Metathesis Polymerization and Hydrogenation of 4-(2-Naphthalene-Methyloxy)-Cinnamate-5-Ethyl Norbornene

The procedures were performed in the same manner as described in Example 67, except that 4-(2-naphthalene-methyloxy)-cinnamate-5-ethyl norbornene (50 mmol) of Example 15 was used as a monomer instead of 4-benzyloxy-cinnamate-5-norbornene of Example 1 to form a polymer (Mw=59k, PDI=3.99, yield=54%).

### Example 82

### Polymer Preparation Using Ring-Opening Metathesis Polymerization and Hydrogenation of 4-(4-Methylketone Benzyloxy)-Cinnamate-5-Norbornene

The procedures were performed in the same manner as described in Example 67, except that 4-(4-methylketone benzyloxy)-cinnamate-5-norbornene (50 mmol) of Example 16 was used as a monomer instead of 4-benzyloxy-cinnamate-5-norbornene of Example 1 to form a polymer (Mw=93k, PDI=3.49, yield=88%).

### Example 83

### Polymer Preparation Using Ring-Opening Metathesis Polymerization and Hydrogenation of 4-(4-Methylketone Benzyloxy)-Cinnamate-5-Methyl Norbornene

The procedures were performed in the same manner as described in Example 67, except that 4-(4-methylketone benzyloxy)-cinnamate-5-methyl norbornene (50 mmol) of Example 17 was used as a monomer instead of 4-benzyloxy-cinnamate-5-norbornene of Example 1 to form a polymer (Mw=85k, PDI=4.26, yield=81%).

### Example 84

### Polymer Preparation Using Ring-Opening Metathesis Polymerization and Hydrogenation of 4-(4-Methylketone Benzyloxy)-Cinnamate-5-Ethyl Norbornene

The procedures were performed in the same manner as described in Example 67, except that 4-(4-methylketone benzyloxy)-cinnamate-5-ethyl norbornene (50 mmol) of Example 18 was used as a monomer instead of 4-benzyloxy-cinnamate-5-norbornene of Example 1 to form a polymer (Mw=94k, PDI=4.56, yield=71%).

### Example 85

### Polymer Preparation Using Ring-Opening Metathesis Polymerization and Hydrogenation of 4-(1-Phenyl Perfluoroheptyloxy)-Cinnamate-5-Norbornene

The procedures were performed in the same manner as described in Example 67, except that 4-(1-phenyl perfluoroheptyloxy)-cinnamate-5-norbornene (50 mmol) of Example 19 was used as a monomer instead of 4-benzyloxy-cinnamate-5-norbornene of Example 1 to form a polymer (Mw=42k, PDI=4.37, yield=54%).

### Example 86

### Polymer Preparation Using Ring-Opening Metathesis Polymerization and Hydrogenation of 4-(1-Phenyl Perfluoroheptyloxy)-Cinnamate-5-Methyl Norbornene

The procedures were performed in the same manner as described in Example 67, except that 4-(1-phenyl perfluoroheptyloxy)-cinnamate-5-methyl norbornene (50 mmol) of Example 20 was used as a monomer instead of 4-benzyloxy-cinnamate-5-norbornene of Example 1 to form a polymer (Mw=45k, PDI=3.92, yield=52%).

### Example 87

### Polymer Preparation Using Ring-Opening Metathesis Polymerization and Hydrogenation of 4-(1-Phenyl Perfluoroheptyloxy)-Cinnamate-5-Ethyl Norbornene

The procedures were performed in the same manner as described in Example 67, except that 4-(1-phenyl perfluoroheptyloxy)-cinnamate-5-ethyl norbornene (50 mmol) of Example 21 was used as a monomer instead of 4-benzyloxy-cinnamate-5-norbornene of Example 1 to form a polymer (Mw=44k, PDI=4.52, yield=43%).

### Example 88

### Polymer Preparation Using Ring-Opening Metathesis Polymerization and Hydrogenation of 4-(4-Benzyloxy)-Benzyloxy-Cinnamate-5-Norbornene

The procedures were performed in the same manner as described in Example 67, except that 4-(4-benzyloxy)-benzyloxy-cinnamate-5-norbornene (50 mmol) of Example 22 was used as a monomer instead of 4-benzyloxy-cinnamate-5-norbornene of Example 1 to form a polymer (Mw=82k, PDI=3.44, yield=70%).

### Example 89

### Polymer Preparation Using Ring-Opening Metathesis Polymerization and Hydrogenation of 4-(4-Benzyloxy)-Benzyloxy-Cinnamate-5-Methyl Norbornene

The procedures were performed in the same manner as described in Example 67, except that 4-(4-benzyloxy)-benzyloxy-cinnamate-5-methyl norbornene (50 mmol) of Example 23 was used as a monomer instead of 4-benzyloxy-cinnamate-5-norbornene of Example 1 to form a polymer (Mw=76k, PDI=3.67, yield=73%).

### Example 90

### Polymer Preparation Using Ring-Opening Metathesis Polymerization and Hydrogenation of 4-(4-Benzyloxy)-Benzyloxy-Cinnamate-5-Ethyl Norbornene

The procedures were performed in the same manner as described in Example 67, except that 4-(4-benzyloxy)-benzyloxy-cinnamate-5-ethyl norbornene (50 mmol) of Example 24 was used as a monomer instead of 4-benzyloxy-cinnamate-5-norbornene of Example 1 to form a polymer (Mw=68k, PDI=4.81, yield=65%).

### Example 91

### Polymer Preparation Using Ring-Opening Metathesis Polymerization and Hydrogenation of 4-(4-Fluoro-Phenyloxy)-Benzyloxy-Cinnamate-5-Norbornene

The procedures were performed in the same manner as described in Example 67, except that 4-(4-fluoro-phenyloxy)-benzyloxy-cinnamate-5-norbornene (50 mmol) of Example 25 was used as a monomer instead of 4-benzyloxy-cinnamate-5-norbornene of Example 1 to form a polymer (Mw=51k, PDI=4.72, yield=41%).

### Example 92

### Polymer Preparation Using Ring-Opening Metathesis Polymerization and Hydrogenation of 4-(4-Fluoro-Phenyloxy)-Benzyloxy-Cinnamate-5-Methyl Norbornene

The procedures were performed in the same manner as described in Example 67, except that 4-(4-fluoro-phenyloxy)-benzyloxy-cinnamate-5-methyl norbornene (50 mmol) of Example 26 was used as a monomer instead of 4-benzyloxy-cinnamate-5-norbornene of Example 1 to form a polymer (Mw=55k, PDI=4.13, yield=47%).

### Example 93

### Polymer Preparation Using Ring-Opening Metathesis Polymerization and Hydrogenation of 4-(4-Fluoro-Phenyloxy)-Benzyloxy-Cinnamate-5-Ethyl Norbornene

The procedures were performed in the same manner as described in Example 67, except that 4-(4-fluoro-phenyloxy)-benzyloxy-cinnamate-5-ethyl norbornene (50 mmol) of Example 27 was used as a monomer instead of 4-benzyloxy-cinnamate-5-norbornene of Example 1 to form a polymer (Mw=49k, PDI=4.11, yield=42%).

### Example 94

### Polymer Preparation Using Ring-Opening Metathesis Polymerization and Hydrogenation of 4-(4-Trifluoromethyl)-Benzyloxy-Cinnamate-5-Norbornene

The procedures were performed in the same manner as described in Example 67, except that 4-(4-trifluoromethyl)-benzyloxy-cinnamate-5-norbornene (50 mmol) of Example 28 was used as a monomer instead of 4-benzyloxy-cinnamate-5-norbornene of Example 1 to form a polymer (Mw=53k, PDI=3.01, yield=56%).

### Example 95

### Polymer Preparation Using Ring-Opening Metathesis Polymerization and Hydrogenation of 4-(4-Trifluoromethyl)-Benzyloxy-Cinnamate-5-Methyl Norbornene

The procedures were performed in the same manner as described in Example 67, except that 4-(4-trifluoromethyl)-benzyloxy-cinnamate-5-methyl norbornene (50 mmol) of Example 29 was used as a monomer instead of 4-benzyloxy-cinnamate-5-norbornene of Example 1 to form a polymer (Mw=72k, PDI=3.95, yield=55%).

### Example 96

### Polymer Preparation Using Ring-Opening Metathesis Polymerization and Hydrogenation of 4-(4-Trifluoromethyl)-Benzyloxy-Cinnamate-5-Ethyl Norbornene

The procedures were performed in the same manner as described in Example 67, except that 4-(4-trifluoromethyl)-benzyloxy-cinnamate-5-ethyl norbornene (50 mmol) of Example 30 was used as a monomer instead of 4-benzyloxy-cinnamate-5-norbornene of Example 1 to form a polymer (Mw=59k, PDI=3.72, yield=50%).

### Example 97

### Polymer Preparation Using Ring-Opening Metathesis Polymerization and Hydrogenation of 4-(4-Bromo-Benzyloxy)-Cinnamate-5-Norbornene

The procedures were performed in the same manner as described in Example 67, except that 4-(4-bromo-benzyloxy)-cinnamate-5-norbornene (50 mmol) of Example 31 was used as a monomer instead of 4-benzyloxy-cinnamate-5-norbornene of Example 1 to form a polymer (Mw=97k, PDI=3.14, yield=80%).

### Example 98

### Polymer Preparation Using Ring-Opening Metathesis Polymerization and Hydrogenation of 4-(4-Bromo-Benzyloxy)-Cinnamate-5-Methyl Norbornene

The procedures were performed in the same manner as described in Example 67, except that 4-(4-bromo-benzyloxy)-cinnamate-5-methyl norbornene (50 mmol) of Example 32 was used as a monomer instead of 4-benzyloxy-cinnamate-5-norbornene of Example 1 to form a polymer (Mw=93k, PDI=3.28, yield=83%).

### Example 99

### Polymer Preparation Using Ring-Opening Metathesis Polymerization and Hydrogenation of 4-(4-Bromo-Benzyloxy)-Cinnamate-5-Ethyl Norbornene

The procedures were performed in the same manner as described in Example 67, except that 4-(4-bromo-benzyloxy)-cinnamate-5-ethyl norbornene (50 mmol) of Example 33 was used as a monomer instead of 4-benzyloxy-cinnamate-5-norbornene of Example 1 to form a polymer (Mw=88k, PDI=3.93, yield=81%).

### Experimental Example 1

### Fabrication of Alignment Layer and Evaluation of Characteristics Thereof

A toluene solution, in which photo-alignment polymers (2 to 3 wt %) of Examples 35 and 44 were dissolved in toluene, was put dropwise onto a glass substrate, and then spin coating was carried out. The spin-coated film was dried at 100° C. for 2 minutes and then exposed to polarized UV radiation having a wavelength of 280 to 315 nm and a predetermined polarization direction to conduct first alignment to form a first alignment layer, and then the first alignment layer was rotated by 90° to turn the polarization direction. The first alignment layer was further exposed to the polarized UV radiation under the same condition to conduct second alignment to form a second alignment layer. The total exposure amount of the polarized UV radiation in the first and second alignments was regulated by the exposure time. The total exposure amount thereof is summarized in Table 1 below.

Meanwhile, the absorbances of the alignment layers after the first and second alignments were respectively measured using a UV-vis spectrometer under the condition of a reference wavelength of 300 nm. From the results of measurement of absorbances thereof, the absorbances (A1 and A2) of the alignment layers after the first and second alignments are deduced, and the absorbance ratio (AR) thereof is represented by the following Mathematical Formula 1:

absorbance ratio(AR)=(|A1−A2|)/(A1+A2) [Mathematical Formula 1]

Here, A1 represents the absorbance of a photo-alignment polymer, which was measured at the maximum absorption wavelength (about 300 nm in this experiment) of wavelengths of 280 to 330 nm after first alignment, and A2 represents the absorbance of a photo-alignment polymer, which was measured at the maximum absorption wavelength (about 300 nm in this experiment) of wavelengths of 280 to 330 nm after second alignment.

Further, after first and second alignments, the ratio of the area of a non-aligned portion (observed by the naked eye) of the alignment layer to the total area of the alignment layer was calculated, and the orientation thereof was evaluated by a five-point criterion. There results thereof are given in Table 1 below.

TABLE 1

| | First | Second | Absor- | | |
|---|---|---|---|---|---|
| ENTRY | exposure | exposure | bance | Orientation | Orientation |
| (used | intensity | intensity | ratio | after first | after second |
| polymer) | (mJ/cm²) | (mJ/cm²) | (AR) | alignment | alignment |
| 1(Ex. 35) | 6.4 | 59.1 | 0.08 | 5 | 5 |
| 2(Ex. 35) | 6.4 | 31.4 | 0.04 | 5 | 5 |
| 3(Ex. 35) | 6.4 | 21.0 | 0.04 | 5 | 5 |
| 4(Ex. 35) | 6.4 | 15.6 | 0.04 | 5 | 5 |
| 5(Ex. 35) | 6.4 | 13.2 | 0.02 | 5 | 4 |
| 6(Ex. 35) | 8.7 | 59.1 | 0.06 | 5 | 5 |
| 7(Ex. 35) | 8.7 | 31.4 | 0.04 | 5 | 5 |
| 8(Ex. 35) | 8.7 | 21.0 | 0.04 | 5 | 5 |
| 9(Ex. 35) | 8.7 | 15.6 | 0.04 | 5 | 5 |
| 10(Ex. 35) | 8.7 | 13.2 | 0.02 | 5 | 4 |
| 11(Ex. 35) | 12.8 | 59.1 | 0.04 | 5 | 5 |
| 12(Ex. 35) | 12.8 | 31.4 | 0.04 | 5 | 5 |
| 13(Ex. 35) | 12.8 | 21.0 | 0.04 | 5 | 5 |
| 14(Ex. 35) | 12.8 | 15.6 | 0.02 | 5 | 5 |
| 15(Ex. 35) | 12.8 | 13.2 | 0.02 | 5 | 4 |
| 16(Ex. 35) | 24.1 | 59.1 | 0.04 | 5 | 5 |
| 17(Ex. 35) | 24.1 | 31.4 | 0.04 | 5 | 5 |
| 18(Ex. 35) | 24.1 | 21.0 | 0.02 | 5 | 5 |
| 19(Ex. 35) | 24.1 | 15.6 | 0.02 | 5 | 4 |
| 20(Ex. 38) | 6.4 | 59.1 | 0.06 | 5 | 5 |
| 21(Ex. 38) | 6.4 | 31.4 | 0.04 | 5 | 5 |
| 22(Ex. 38) | 6.4 | 21.0 | 0.04 | 5 | 5 |
| 23(Ex. 38) | 6.4 | 15.6 | 0.04 | 5 | 5 |
| 24(Ex. 38) | 6.4 | 13.2 | 0.02 | 5 | 4 |
| 25(Ex. 38) | 24.1 | 59.1 | 0.04 | 5 | 5 |
| 26(Ex. 38) | 24.1 | 31.4 | 0.04 | 5 | 5 |
| 27(Ex. 38) | 24.1 | 21.0 | 0.02 | 5 | 5 |
| 28(Ex. 38) | 24.1 | 15.6 | 0.02 | 5 | 4 |
| 29(Ex. 44) | 6.4 | 59.1 | 0.04 | 4 | 4 |
| 30(Ex. 44) | 6.4 | 31.4 | 0.02 | 4 | 4 |
| 31(Ex. 44) | 6.4 | 21.0 | 0.02 | 4 | 4 |
| 32(Ex. 44) | 24.1 | 59.1 | 0.02 | 4 | 4 |
| 33(Ex. 44) | 24.1 | 31.4 | 0.02 | 4 | 4 |

Referring to Table 1 above, it can be ascertained that entry 1 to 33 (Examples 35, 38 and 44), each of which satisfies an absorbance ratio of 0.02 or more, exhibit excellent orientation even after the first and second alignments. Particularly, it can be ascertained that the change in alignment direction to polarization direction is free even after the second alignment, thus exhibiting excellent orientation.

1. A photo-alignment polymer comprising a cyclic olefin repeating unit substituted with one or more photoreactive groups,
wherein, when the photo-alignment polymer is exposed to first polarized UV radiation having a wavelength of 280 to 315 nm and a first polarization direction at an exposure intensity of 60 mJ/cm² or less to conduct first photo-alignment and is then exposed to second polarized UV radiation having a wavelength of 280 to 315 nm and a second polarization direction changed by 90° from the first polarization direction at an exposure intensity of 60 mJ/cm² or less to conduct second photo-alignment,
the photo-alignment polymer has an absorbance ratio of 0.02 or more, the absorbance ratio being defined by Mathematical Formula 1 below:
absorbance ratio(AR)=(|A1−A2|)/(A1+A2) [Mathematical Formula 1]
wherein A1 represents an absorbance of the photo-alignment polymer, which was measured at a maximum absorption wavelength of wavelengths of 280 to 330 nm after the first photo-alignment, and A2 represents an absorbance of the photo-alignment polymer, which was measured at a maximum absorption wavelength of wavelengths of 280 to 330 nm after the second photo-alignment.

2. The photo-alignment polymer of claim 1, wherein the absorbance ratio (AR) is 0.02 to 0.08

3. The photo-alignment polymer of claim 1, wherein the absorbance ratio (AR) is 0.02 to 0.05, when the exposure intensity in the first alignment is 20 to 60 mJ/cm² and the exposure intensity in the second alignment is 30 to 60 mJ/cm².

4. The photo-alignment polymer of claim 1, wherein the absorbance ratio (AR) is 0.02 to 0.08, when the exposure intensity in the first photo-alignment is 3 to 20 mJ/cm² and the exposure intensity in the second photo-alignment is 3 to 60 mJ/cm².

5. The photo-alignment polymer of claim 4, wherein the absorbance ratio (AR) is 0.04 to 0.08, when the exposure intensity in the second photo-alignment is 15 to 60 mJ/cm².

6. The photo-alignment polymer of claim 1, wherein the cyclic olefin repeating unit includes a repeating unit of the following Formula 3a or 3b: 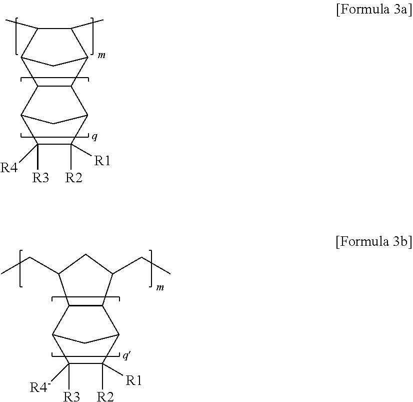
wherein independently, m is 50 to 5,000;
q is an integer from 0 to 4;
at least one of R1, R2, R3 and R4 is any one selected from the group consisting of radicals represented by the following Formulae 1a and 1b,
among R1 to R4, the remainders other than the radical of Formula 1a or 1b are the same as or different from one another and independently selected from the group consisting of hydrogen; halogen; substituted or unsubstituted linear or branched alkyl having 1 to 20 carbon atoms; substituted or unsubstituted linear or branched alkenyl having 2 to 20 carbon atoms; substituted or unsubstituted linear or branched alkynyl having 2 to 20 carbon atoms; substituted or unsubstituted cycloalkyl having 3 to 12 carbon atoms; substituted or unsubstituted aryl having 6 to 40 carbon atoms; and a polar functional group comprising at least one of oxygen, nitrogen, phosphor, sulfur, silicon, and boron,
when R1 to R4 are not hydrogen, halogen, or a polar functional group, at least one of a R1 and R2 combination and a R3 and R4 combination is bonded to each other to form an alkylidene group having 1 to 10 carbon atoms; or R1 or R2 is bonded to either R3 or R4 to form a saturated or unsaturated aliphatic ring having 4 to 12 carbon atoms or an aromatic ring having 6 to 24 carbon atoms, 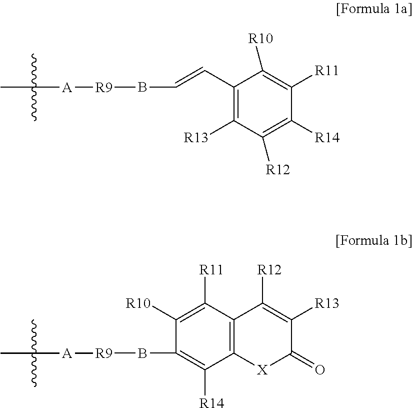
wherein A is chemical bond, oxygen, sulfur, or —NH—;
B is selected from the group consisting of chemical bond, substituted or unsubstituted alkylene having 1 to 20 carbon atoms, carbonyl, carboxy, ester, substituted or unsubstituted arylene having 6 to 40 carbon atoms, and substituted or unsubstituted heteroarylene having 6 to 40 carbon atoms;
X is oxygen or sulfur;
R9 is selected from the group consisting of chemical bond, substituted or unsubstituted alkylene having 1 to 20 carbon atoms, substituted or unsubstituted alkenylene having 2 to 20 carbon atoms, substituted or unsubstituted cycloalkylene having 3 to 12 carbon atoms, substituted or unsubstituted arylene having 6 to 40 carbon atoms, substituted or unsubstituted aralkylene having 7 to 15 carbon atoms, and substituted or unsubstituted alkynylene having 2 to 20 carbon atoms;
at least one of R10 to R14 is a radical represented by -L-R15-R16-(substituted or unsubstituted C6-C40 aryl),
among R10 to R14, the remainders other than the radical of -L-R15-R16-(substituted or unsubstituted C6-C40 aryl) are the same as or different from one another and independently selected from the group consisting of hydrogen; halogen; substituted or unsubstituted alkyl having 1 to 20 carbon atoms; substituted or unsubstituted alkoxy having 1 to 20 carbon atoms; substituted or unsubstituted aryloxy having 6 to 30 carbon atoms; substituted or unsubstituted aryl having 6 to 40 carbon atoms; and heteroaryl having 6 to 40 carbon atoms with a hetero element in Group 14, 15 or 16;
L is selected from the group consisting of oxygen, sulfur, —NH—, substituted or unsubstituted alkylene having 1 to 20 carbon atoms, carbonyl, carboxy, —CONH—, and substituted or unsubstituted arylene having 6 to 40 carbon atoms;
R15 is substituted or unsubstituted alkyl having 1 to 10 carbon atoms; and
R16 is selected from the group consisting of chemical bond, —O—, —C(═O)O—, —OC(═O)—, —NH—, —S—, and —C(═O)—.

7. The photo-alignment polymer of claim 6, wherein the radical of -L-R15-R16-(substituted or unsubstituted C6-C40 aryl) is represented by the following Formula 2: 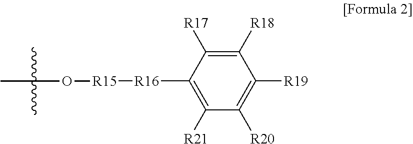
wherein R15 and R16 are as defined in Formula 1; and
R17 to R21 are the same as or different from one another and independently selected from the group consisting of hydrogen; halogen; substituted or unsubstituted alkyl having 1 to 20 carbon atoms; substituted or unsubstituted alkoxy having 1 to 20 carbon atoms; substituted or unsubstituted aryloxy having 6 to 30 carbon atoms; substituted or unsubstituted aryl having 6 to 40 carbon atoms; heteroaryl having 6 to 40 carbon atoms with a hetero element in Group 14, 15 or 16; and substituted or unsubstituted alkoxyaryl having 6 to 40 carbon atoms.

8. The photo-alignment polymer of claim 7, wherein the radical represented by the above Formula 2 is unsubstituted benzyloxy or benzyloxy substituted with halogen or alkoxy having 1 to 3 carbon atoms.

9. The photo-alignment polymer of claim 6, wherein the photo-alignment polymer has a weight average molecular weight of 10,000 to 1,000,000.

10. An alignment layer comprising the photo-alignment polymer of claim 1.

11. A liquid crystal retardation film comprising: the alignment layer of claim 10; and a liquid crystal layer formed on the alignment layer.

12. The liquid crystal retardation film of claim 11, wherein the alignment layer includes two kinds of alignment layers having different photo-alignment polymer alignment directions from each other, and the liquid crystal layer is divided into two regions by each of the alignment layers and is patterned.

13. A display device comprising the alignment layer of claim 10.

14. A display device comprising the liquid crystal retardation film of claim 11.

15. The display device of claim 14, wherein the display is device is a three-dimensional display device.

16. An alignment layer comprising the photo-alignment polymer of claim 9.

17. A display device comprising the liquid crystal retardation film of claim 12.
